(19) United States
(12) Patent Application Publication
(10) Pub. No.: US 2026/0217387 A1
(43) Pub. Date: Jul. 30, 2026

(54) Generalized Method for Orbital Launch Trajectories

(71) Applicant: Akcasu Hypersonics, LLC, Cardiff-by-the-Sea, CA (US)

(72) Inventor: Osman Ersed Akcasu, Cardiff-by-the-Sea, CA (US)

(21) Appl. No.: 19/308,264

(22) Filed: Aug. 24, 2025

(51) Int. Cl. B64G 1/24; G06F 17/11

(52) U.S. Cl. CPC B64G 1/242; B64G 1/244; G06F 17/11

(57) ABSTRACT

The method launches a satellite as high as a first height (rₕ), with respect to the center of the Earth given as rₕ₁=s_{f}·a_{ORBIT} (or s_{f}·r_{ORBIT}) where 1.1<s_{f}<2 where a_{ORBIT} is the semi-major axis of the stable elliptical orbit (r_{ORBIT} for circular orbits). Then the descent stage, with satellite, starts free-fall in response to a gravitational pull of the Earth along with the assistance of the rocket propulsion applied in the direction of the selected orbital injection point, into the stable orbit. An analytical formulation is derived using the conservation of energy principle equating the total energy in the stable orbit to the first total energy, adjusted due to propellant consumed during the descent given below,

providing the ability to launch satellites from any point on earth to any orbital inclination directly with no launch azimuth restrictions using less propellant or larger payloads with the same propellant,

$${r}_{h} = \frac{1}{{\frac{1}{2 GM} [ {v}_{e} l n ( 1 + \frac{{m}_{PROP}}{{m}_{ORBIT}} ) ]}^{2} + \frac{1}{2 {a}_{ORBIT}}} .$$

### BACKGROUND OF THE INVENTION

### Field of the Invention

The patent entitled “Efficient Method for Orbital Launch Trajectories”, U.S. Pat. No. 12,172,774 B1, with the issue date of Dec. 24, 2024, which is incorporated herein by reference, provides some foundation for the orbital injection of an Earth revolving satellite in a circular orbit [1]. As described therein, to launch a satellite to a circular orbit with a radius of r_{ORBIT}, a distance measured from the center of the Earth, the rocket is first launched with its descent stage, rocket engines, propellant, and satellite (payload) to a height r₀, defined with respect to the Earth's center, that is greater than to its final circular orbital radius of r_{ORBIT}. The relationship between r₀ and r_{ORBIT} is derived based on energy conservation laws for a constant mass, with the assumption that the mass at r₀, m₀ and the mass at r_{ORBIT}, m_{ORBIT} are the same, remaining constant during descent. In other words, when the satellite and its descent stage reach the height r₀, it is in a non-orbital energy state, meaning that if no energy is supplied to the system, the satellite and its descend stage will fall back to Earth, but not into an orbit. For an ideal case of a vertical launch perpendicular to the Earth's surface, or in other words, in radial direction with respect to the center of the Earth, when the satellite reaches the peak distance from the center of the Earth, which is given as r₀, derived as a function of r_{ORBIT}, it becomes stationary, having just potential energy with zero kinetic energy. Since there is a need for rocket thrust at r₀ to get in the desired stable orbit at r_{ORBIT}, the descend stage consumes mass.

It would be advantageous if the above-described method could be generalized to support the launch of payloads into a broader class of orbit types, such as elliptical orbits.

It would be advantageous if the above-described method could be launched to a height to optimally account for the difference in gravitational potential between the differences in mass at the peak and orbital heights.

### SUMMARY OF THE INVENTION

Disclosed herein is a method of launch trajectories for a variety of orbital configurations including elliptical trajectories as well as circular trajectories, where a circle is a special case of an ellipse having its eccentricity equal to zero. In this work an analytical expression is derived which relates the rocket thrust required during the descent stage as a function of propellant mass m_{PROP} which is a function of the m_{ORBIT} to m_{O} ratio, the orbital semi-major axes a_{ORBIT} and specific impulse I_{SP} or vₑ, the relative rocket exhaust gas velocity with respect to the rocket appears in the Tsiolkovsky Rocket Equation for not only circular, also elliptical orbits. Although the final calculations are done by series of iterative solutions of non-linear equations based on the numerical simulations of the equation of the motion in inverse square law gravitational field in [1] and here, having an analytical initial approximation applicable for any orbit for the solution greatly reduces computational effort in finding the launch and descend parameters as well as better understanding of the methodologies employed. The simulated significant propellant savings employing this method with several launch parameters are also given.

The rocket business is dangerous, full of violent accidents involving big explosions during a rocket launch. To minimize collateral damage in case of an accident in any rocket launch, the common strategy is to let the rocket reach a given safety altitude h_{L} vertically after it is cleared away from the launch site. Then, the rocket is initially given a small angle of ascend with respect to vertical, such as θ_{L}=50 as in all of the simulations done in this work. This shouldn't be confused with the pitch-over maneuver in the gravity turn used in prior art launch methodology [1, 6]. If the rocket is not aligned back to vertical direction at a later time, then when the rocket reaches its peak distance r₀ from the center of the Earth, it has a non-zero tangential velocity, with respect to the gravitational equipotential sphere around the center of the Earth with a radius of r₀. This means that the kinetic energy of the rocket when it reaches its peak distance from the center of the Earth will not be zero, but it will be very small compared to its potential energy. The kinetic energy is related to the square of the velocity, as seen in FIG. 3G and the log scale plot of FIG. 3H, which show the velocity components of a spacecraft during the climb stage. At this altitude the rocket is still in a non-orbital energy state, and if no energy is supplied to it will fall back to Earth as shown in FIG. 5 and FIG. 14, which are based on an exact numerical simulation for trajectories in an inverse square law gravitational field for various launch angles with respect to vertical. As can be seen, these are all non-orbital ballistic trajectories.

During the descent, the descent stage rocket is activated typically twice. The first rocket burn is to bring the descent stage with its orbital payload from rₕ towards the orbital injection point (OIP) on the stable orbit. There are basically 2 different strategies of doing this first rocket burn, which both are explained in detail in this work.

The second descent stage rocket is activated in the vicinity of the targeted stable orbit such that its descent trajectory becomes tangent to the desired orbital trajectory and gives the same orbital velocity vector when it reaches the orbital injection point (OIP). This second rocket burn can be viewed as the “fine tuning of the velocity vector” done in the vicinity of the orbital injection point. This descent maneuver also consumes propellant, but is far less than the first ascending rocket burn if planned properly. At this point the descent stage is in its desired orbit and has a mass (m_{ORBIT}) which includes the mass of the satellite m, and is attached by clamps or bolts that can be release by a “separation system”. The last remaining action is commonly known as “separation”, which is the separation of the orbital payload (satellite) mass m, employing convention separation means in use since at least 1957, such as spring mechanisms, small thrusters, pyrotechnic devices, or pneumatic actuators. Activating the separation system does not change the mass of the overall system, and separates the satellite from the descent stage, which contains the descent stage rocket, its depleted propellant tank, and the auxiliary mass needed for guidance and control, having a total mass of m_{DEC}, becoming space debris, which after a controlled deorbit burn may reenter the atmosphere and be burned due to its high orbital speed, or in some cases may be parked in a disposal orbit.

As a result of these two rocket burns at two different times during the descend, the orbital mass m_{ORBIT} is less than the mass m_{O}, which is defined as the mass of the satellite, propellant, and descent stage at its peak distance away from the center of the earth, which is coined as the target height (rₕ₁) in this work. This mass difference is basically equal to the total amount of consumed propellant mass m_{PROP} in the entire descent which is taken into consideration in deriving the new energy balance equations starting from relation (2.13).

The stable elliptical orbit of a satellite around the Earth can be defined by 6 orbital parameters, basically defining any three-dimensional trajectory listed along with their commonly used symbols as:
h Specific angular momentum
i Inclination
Ω Right Ascension of the ascending node
e Eccentricity
ω Argument and Perigee
θ True anomaly.

All the orbital calculations can be performed in an “orbital plane” given by an inclination angle with respect to the equatorial plane. This is mathematically equivalent doing all the calculations in a three-dimensional orbit with 6 orbital parameters, but leads to simpler calculations and is much easier to visualize.

The method first launches a satellite to a target height (rₕ₁) as high as a first height (rₕ), defined with respect to the center of the Earth. A gravitational first potential energy is attained at the target height with approximately zero kinetic energy if launched at a non-zero ascent angle with respect to vertical. Then, the satellite height decreases in response to a gravitational pull of the Earth. With some assist from a descent rocket the satellite attains a stable orbit around the Earth that can be defined by an ellipse having the formula on the orbital plane:

$$\frac{{x}^{2}}{{a}^{2}} + \frac{{y}^{2}}{{b}^{2}} = 1 ;$$

where a is a semi-major axis along the x axis passing through the Earth, where b is a semi-minor axis along the y axis, orthogonal to the x axis, and where the center of the Earth is one of the foci of the ellipse. Since the descent rocket thrust is not in opposition to the direction of gravitational force, as in prior art gravity turn methods, the potential energy conversion to kinetic energy during descent results in a significant propellant savings. In the stable orbit the satellite has a total energy that is the sum of its gravitational second potential energy and its second kinetic energy, with the satellite total energy being equal to gravitational first potential energy attained at the target height. If a=b, then the stable orbit is circular. If a>b, then the stable orbit is elliptical. For simplicity it can be assumed that the orbital mass m_{ORBIT} is represented by m, the mass of the satellite in orbit.

In greater detail, the total energy (TE) of the satellite in the stable elliptical orbit is equal to its second kinetic energy (KE) plus its second potential energy (PE) defined by the formula:

$$TE = KE + PE = \frac{1}{2} m {v}^{2} - G \frac{m M}{r} ;$$

where m is the mass of the satellite;
where M is the mass of the Earth;
where G is the universal gravitational constant;
where v is the velocity of the satellite; and,
where r is the orbital position of the satellite from the center of the Earth. Note, in the case of a circular orbit r is a constant value. In the case of an ellipse, the value of r varies, as does the velocity of the satellite in orbit. The satellite velocity in an elliptical stable orbit is defined by the formula:

$$v ( r ) = \sqrt{G M ( \frac{2}{r} - \frac{1}{a} )} .$$

Thus, the satellite TE in the stable elliptical orbit can be redefined by the formula:

$$T E = \frac{1}{2} G m M ( \frac{2}{r} — \frac{1}{a} ) - G \frac{m M}{r} ;$$

$$= GmM ( \frac{1}{r} - \frac{1}{2 a} - \frac{1}{r} ) ;$$

$$= - G \frac{M m}{2 a} .$$

Whether the orbit is elliptical or circular it can be seen that when the satellite has the gravitational first potential energy at the first height, it is equal to the satellite TE in orbit as defined by the formula:

$$- G \frac{m M}{{r}_{h}} = - G \frac{M m}{2 a} .$$

As a result, it can be seen that in this particular case the relationship between the first height (rₕ) and the maximum height of the orbit (semi-major axis) is defined as:

$${r}_{h} = 2 a .$$

The climb altitude h_{CLIMB}, which is the altitude of the satellite from the sea level be can written as,

$${h}_{CLIMB} = {r}_{h} - {r}_{EARTH}$$

Advantageously, this method permits a satellite to attain a stable orbit at any orbital inclination angle in the range between 0 and 360 degrees, and also permits the launching a payload from any latitude on a surface of the Earth in the range between 90 and −90 degrees, for any launch azimuth permitted at the launch site.

In one aspect, the satellite is included with a descent rocket and descent rocket propellant as part of a payload that is launched tangential to the target height (rₕ₁) defined with respect to the center of the Earth, where

$${r}_{h 1} = {s}_{f} \cdot a where 1.1 < {s}_{f} , 2$$

Since the mass of the payload is greater than just the satellite, the payload is able to attain the gravitational first energy potential at a target height that is lower (closer to the Earth) than the first height.

TABLE 1

| | | Launch Altitude | Launch Altitude | Launch Altitude |
|---|---|---|---|---|
| | | [km] and | [km] and | [km]\| and |
| Orbital | | $η = \frac{( Launch Altitude )}{( Orbital Altitude )}$ | $η = \frac{( Launch Altitude )}{( Orbital Altitude )}$ | $η = \frac{( Launch Altitude )}{( Orbital Altitude )}$ |
| Altitude [km] | | for s_{f} = 1.1 | for s_{f} = 1.5 | for s_{f} = 2 |
| 255 | (GOCE) | (918 km) \| (η = 3.6) | (3,571 km) \| (η = 14) | (6,888 km)\| (η = 27) |
| 400 | (ISS) | (1,077 km) \| (η = 2.69) | (3,789 km) \| (η = 9.4) | (7,178 km) \| (η = 17.94) |
| 540 | (Hubble) | (1,231 km) \| (η = 2.28) | (3,999 km) \| (η = 7.40) | (7,458 km) \| (η = 13.81) |
| 781 | (Iridium) | (1,497 km) \| (η = 1.916) | (4,360 km) \| (η = 5.583) | (7,940 km) \| (η = 10.16) |
| 20,200 | (GPS) | (22,857 km) \| (η = 1.13) | (33,489 km) \| (η = 1.657) | (46,778 km) \| (η = 2.315) |
| 35,786 | (GEO) | (40,002 km) \| (η = 1.11) | (56,868 km) \| (η = 1.589) | (77,950 km) \| η = 2.178) |

Table 1 presents satellite altitude at perigee of several satellites and their launch altitudes, as a function of s_{f}=1.1, 1.5, and 2. See the markings on FIG. 4C.

### Satellite Names and Launch Masses:

GOCE: 1,000 [kg], ESA Gravity Field and Steady-State Ocean Circulation Explorer,
ISS: International Space Station (Multiple Launches),
Hubble: 11,110 [kg],
Iridium: 689 [kg],
GPS Block 11F: 1,630 [kg],
Latest Geo-Synchronous satellite: 4,276 [kg].

This method has several advantages other than energy savings, such as the ability to launch larger payloads to the same orbit, as compared to the existing methods, and/or with the same booster using less propellant. This not only saves propellant per launch but reduces the yearly number of launches necessary for achieving a given yearly launch budget. Each launch being on the order of $100,000,000 as shown in Table 3, the savings are substantial as well as being more environmentally friendly. Another savings results from the flexibility of launching satellites to any inclination angle, independent of launch azimuth restrictions from anywhere on the Earth's surface without costly inclination plane angle adjustment maneuvers.

Additional details of the orbital launch method are provided below.

### BRIEF DESCRIPTION OF THE DRAWINGS

FIG. 1 is a diagram of a standard ellipse centered at the origin with a width of 2a and a height of 2b.

FIG. 2 is a diagram of a satellite in an elliptical orbit, showing the a≤rₕ≤2a and its corresponding 1≤s_{f}≤2 boundary where the descent stage is launched.

FIG. 3A depicts the relation between the launch azimuth angle and the inclination angle as described by (3.1) for several launch sites where most space launches are performed, see Table 1.

FIG. 3B depicts the percentage of velocity change as given in (3.2) as a function of orbital plane change, with markings for the 5 launch sites given in Table 2.

FIG. 3C depicts the amount of extra propellant (mass) that must be burned to achieve the orbital plane change, for a satellite with a 1 ton of orbital payload mass, to GTO orbit as a function of orbital plane change, with markings for each launch site in Table 2 and the orbital radii given in Table 1.

FIGS. 3D-3F depict the calculated propellant, thrust, and related burn times with a constant burn rate for orbital plane change maneuvers at the orbital altitudes of 255 kilometers (km), 781 km, 20,200 km, and 35,786 km with a 1 ton payload to GTO as a function of orbital plane change, with markings for each launch site listed in Table 2 and the orbital radii listed in Table 1.

FIGS. 3G and 3H are linear and logarithmic plots, respectively, depicting the magnitude of the ascent velocity vector |v(t)| and its velocity component v_{y}(t) in the direction along its trajectory for an elliptical orbit with a perigee of 35,786 km, where rₕ=1.2a (s_{f}=1.2).

FIG. 3I depicts the percentage of launch mass savings as a function of s_{f} for the orbital altitudes of 400 km, 540 km, 781 km, 20,200 km, and 35,786 km with a 1 ton payload.

FIG. 3J depicts the total m₀ and propellant mass m_{PROP} for ascension, launching orbital payloads of 1, 8, and 64 Tons to a target altitude of 255 km with s_{f} in the range of 1≤s_{f}≤2, where s_{f}=rₕ/a_{ORBIT}.

FIG. 3K depicts the total m_{0DESCEND} and propellant mass m_{PROP_DESCEND} in descent with orbital payloads of 1, 8, and 64 Tons to the target altitude of 255 km with s_{f} in the range of 1≤s_{f}≤2, where s_{f}=rₕ/a_{ORBIT}.

FIG. 3L depicts the total m₀ and propellant mass m_{PROP} for ascension, launching orbital payloads of 1, 8, and 64 Tons to a target altitude of 761 km with s_{f} in the range of 1≤s_{f}≤2, where s_{f}=rₕ/a_{ORBIT}.

FIG. 3M depicts the total m_{0DESCEND} and propellant mass m_{PROP_DESCEND} in descent with orbital payloads of 1, 8, and 64 Tons to the target altitude of 761 km with s_{f} in the range of 1≤s_{f}≤2, where s_{f}=rₕ/a_{ORBIT}.

FIG. 3N depicts the rocketry key parameters μ_{A}=(m_{PROP}/m_{O}), for ascend and

μD=(m_{PROP}/m_{O}) for descend at 255, 781, and 35,786 km launch altitudes.

FIG. 3O is a flowchart illustrating a method of launch trajectories for one of a plurality of potential orbital configurations.

FIG. 4A is a diagram depicting exemplary orbital relationships.

FIG. 4B is a diagram depicting the relationship between rₕ and orbital altitude of 255 km, 400 km, 540 km, 781 km, 20,200 km, and 35,786 km.

FIG. 4C is a diagram depicting the relationship between climb altitude and orbital altitudes of 255 km, 400 km, 540 km, 781 km, 20,200 km, and 35,786 km.

FIG. 4D is a diagram depicting the relationship between

$$η = \frac{{h}_{CLIMB}}{{h}_{ORBIT}}$$

and orbital altitudes of 255 km, 400 km, 540 km, 781 km, 20,200 km, and 35,786 km.

FIG. 5 is a diagram depicting launch angles of 5, 30, 45, 60, 75, and 85 degrees from vertical with corresponding variances in launch heights to obtain a circular orbit with a radius of a.

FIG. 6 is a flowchart illustrating another aspect of launch trajectories for one of a plurality of potential orbital configurations.

FIG. 7 is a flowchart illustrating another variation of a method of obtaining launch trajectories for a number of orbital configurations.

FIG. 8 is a diagram depicting an elliptical orbital plane plot with a perigee of 400 kilometers (km) where rₕ₁=1.7a (1.7a_{ORBIT}), which is s_{f}=1.7.

FIG. 9 is a diagram of the ascent time r(t) for an elliptical orbit with a perigee of 400 km from the center of the Earth, where rₕ₁=1.7a (s_{f}=1.7).

FIG. 10 is a diagram of the ascent velocity for an elliptical orbit with a perigee of 400 km, where rₕ₁=1.7a (s_{f}=1.7).

FIG. 11 is a diagram depicting r(t) and h(t) descent for an elliptical orbit, where rₕ₁=1.7a (s_{f}=1.7).

FIG. 12 is a diagram depicting the descent velocity profile for an elliptical orbit, where rₕ₁=1.7a (s_{f}=1.7).

FIG. 13 is a diagram depicting the orbital injection velocity required for an elliptical orbit, where rₕ₁=1.7a (s_{f}=1.7).

FIG. 14 is a diagram depicting ballistic trajectories for the launch angles of 5, 30, 45, 60, and 70 degrees, where rₕ₁=1.2a (s_{f}=1.2) and the slightly elliptical orbit with a perigee of 35,786 km.

FIG. 15 is a plan view of launch examples with the Earth centered on the polar axis.

FIG. 16 is a diagram depicting the energy associated with launching a payload at an angle of 5 degrees.

FIG. 17 is a diagram depicting an orbital plane plot for a circular orbit with a perigee of 400 km, with r=a and rₕ=2a.

FIG. 18A is a cross-sectional diagram depicting a payload reaching the target height rₕ₁ and attaining alignment in that position in x₂ and y₂ planes.

FIG. 18B is a plan view of FIG. 18A depicting the rotation of the payload from the (x₂, y₂) plane to (x₁, y₁) plane associated with the orbit that the satellite will ultimately attain.

FIG. 18C is a cross-sectional view depicting the payload initially descending, due to gravitational potential, in the desired inclination angle, which is in the (x₁, y₁) plane, followed by the velocity adjustment thrust required to align the satellite with its desired orbit.

FIGS. 19A through 19I and FIGS. 20A through 20M respectively depict examples of two step and three step descent methods.

FIG. 21 depicts rₕ/a as a function of s_{f} for orbital altitudes of 255 km, 400 km, 540 km, 781 km, 20,200 km, and 35,786 km, for vₑ=3,000 [m/s].

### DETAILED DESCRIPTION

Most satellites are launched into elliptical orbits. A satellite in orbit around the Earth obeys 3 laws given by Kepler, as well as Newton's laws of mechanics describing an elliptical orbit. Any satellite orbit is defined by 6 parameters. For the orbital mechanics in this work, the calculations are simplified as being based only on a two-dimensional orbital plane, where the center of the Earth is at one of the focal points of the ellipse.

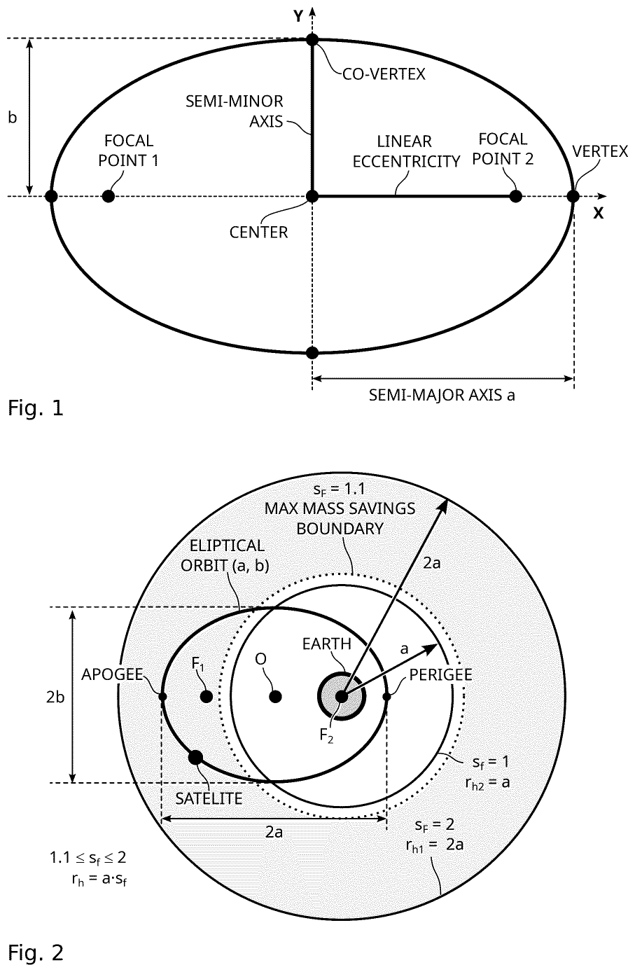

FIG. 1 is a diagram of a standard ellipse centered at the origin with a width of 2a and a height of 2b. The figure is defined by the following equation:

$$\frac{{x}^{2}}{{a}^{2}} + \frac{{y}^{2}}{{b}^{2}} = 1 \qquad ( 1.1 )$$

For an ellipse, it is assumed that a>b, where a and b are the semi-major and semi minor axes of the ellipse, respectively. For an ellipse center at the origin and its major axes aligned with X axis as shown in FIG. 1, the distance between the center of the ellipse and its focal points F₁ and F₂ is,

$$c = \sqrt{{a}^{2} - {b}^{2}} \qquad ( 1.2 )$$

The distance between the center of the ellipse and its focal points F₁ and F₂ is 2c.

An ellipse also can be defined as a plane curve surrounding two focal points, such that for all points on the curve the sum of the two distances to the focal points is a constant and is given as,

$${d}_{1} + {d}_{2} = 2 a \qquad ( 1.3 )$$

In other words, the sum of the distances from one focal point to the ellipse boundary (d₁) and back to the other focal point (d₂) is always equal to 2a.

The eccentricity (e) of an elliptical orbit is a measure of how much the orbit deviates from being a perfect circle. It ranges from 0, giving a perfect circle, to values approaching 1 for an elongated ellipse and is formulated as,

$$e = \frac{c}{a} = \sqrt{1 - \frac{{b}^{2}}{{a}^{2}}} \qquad ( 1.4 )$$

Some other useful definitions common to elliptical orbits are following:

Apogee is the point in the orbit of a satellite at which it is furthest from the Earth's center.

Perigee is the point in the orbit of a satellite at which it is closest to the Earth's center.

Periapsis is the distance from the satellite to the center of the central body when it is at its closest.

Apoapsis is the distance from the satellite to the center of the central body when it is at its farthest.

Apse Line is the major axes which connects the two foci of the ellipse and goes through both aspides, the line intersecting both focal points.

True Anomaly is the angle θ between the satellite's position and the periapsis which is the angular position of an object along its elliptical orbit, relative to its closest approach to the central body.

The eccentricity in an elliptical orbit can be found from its radius to Periapsis rₚ and its radius to Apoapsis rₐ as,

$$e = \frac{{r}_{a} - {r}_{p}}{{r}_{a} + {r}_{p}} \qquad ( 1.5 )$$

Finally, the parametric equations for ellipse are given as,

$$x ( t ) = a \cdot Cos ( t ) and y ( t ) = b \cdot Sin ( t ) \qquad ( 1.6 )$$

Where 0≤t≤2π.

FIG. 2 is a diagram of a satellite in an elliptical orbit, showing the a≤rₕ≤2a and its corresponding 1≤s_{f}≤2 boundary where the descent stage is launched. The dotted circle corresponds to 1.1≤s_{f}≤2 region in the claims drawn in shaded area. A number of points at a distance rₕ from the center of the Earth are depicted. The total energy (TE) of an object, which is the sum of kinetic and potential energies, like a satellite in an elliptical orbit around a central body, is constant and is expressed with the formula,

$$T E = - G \frac{M m}{2 a} = - μ \frac{m}{2 a} \qquad ( 1.7 )$$

Where G, M, and m are the universal gravitational constant, mass of Earth, and mass of the satellite, respectively. The symbol μ is known as standard gravitational parameter and is expressed as,

$$μ = G \cdot M \qquad ( 1.8 )$$

The numerical values of the constants in (1.7) are,

Universal Gravitational Constant G=6.674×10⁻¹¹ [m³·kg⁻¹] or [N·m²·kg⁻²]

Mass of Earth M=5.972×10²⁴ [kg]

The Earth is placed in one of the foci of the elliptical orbit, as shown with a dotted circle in FIG. 2, where ellipse is drawn with its major axes in vertical direction. The Earth's Polar and Equatorial radiuses are slightly different and are,

$${r}_{E P o l a r} = 6 , 357 [ km ] and {r}_{EEqutorial} = 6 , 378 [ km ]$$

This 21 km difference between the Polar and Equatorial radiuses makes the Earth an imperfect sphere, but rather a “oblate spheroid”, like all spinning celestial bodies. The Earth's geometry, being an oblate spheroid, causes gravitational potential also to be a function of the angle from the spin axes of the Earth, which can be calculated with the help of spherical harmonic functions [3-5]. This causes some perturbations in the orbit, and is ignored in the calculations in this work in the interest of simplicity [3-5]. Using Kepler's laws and conservation of angular momentum, the velocity of a satellite in an elliptical orbit can be expressed as,

$$v ( r ) = \sqrt{μ ( \frac{2}{r} - \frac{1}{a} )} \qquad ( 1.9 )$$

Where r represents the radial distance from the satellite to the central body center (e.g., the Earth), and is given as,

$$r ( θ ) = \frac{a ( 1 - {e}^{2} )}{1 + e \cdot Cos ( θ )} \qquad ( 1.1 )$$

Where θ is the true anomaly defined above. Thus, the kinetic energy (KE) of a mass m with a velocity of V is,

$$KE = \frac{1}{2} {mv}^{2} \qquad ( 1.11 )$$

Since the velocity of a satellite with a mass m in an elliptical orbit is a function of its location in the orbit as given in (1.9), its kinetic energy is also a function of its position on the orbit.

The magnitude of the angular momentum, which is generally represented by h in most orbital mechanics, is a constant in an elliptical orbit and can be expressed as,

$$h = \sqrt{2 μ ( \frac{{r}_{a} \cdot {r}_{p}}{{r}_{a} + {r}_{p}} )} \qquad ( 1.12 )$$

Note that in circular orbits (rₐ=rₚ) and magnitude of the angular momentum (1.12) reduces to,

$${h}_{circular} = \sqrt{μ r} \qquad ( 1.13 )$$

The well-known total energy of an orbiting mass m in a circular orbit r around a central body (e.g., the Earth) is,

$$TE = - G \frac{mM}{2 r} \qquad ( 2.1 )$$

The potential energy (PE) of an object with a mass m at a distance of r from the center of a central body M is,

$$PE = - G \frac{mM}{r} \qquad ( 2.2 )$$

In an elliptical orbit, where the satellite is orbiting a central body, the distance r is not constant as with circular orbits, it changes with its position in the orbit as given by (1.10), and therefore it is not be a constant as in the circular orbits discussed in [1].

The first two of the Kepler's laws of planetary motion, published by Johannes Kepler (1571-1630) in 1609, are based on the observations of Tycho Brahe (1546-1601) which describe the orbits of planets around the Sun. These laws replaced circular orbits and epicycles proposed by Nicholas Copernicus (1473-1543) known as heliocentric theory with elliptical orbits.

Kepler's three laws are:

The orbit of a planet is an ellipse with the Sun at one of the two foci,

A line segment joining a planet and the Sun sweeps out equal areas during equal intervals of time. The second law, also known as the equal area law, states that when a planet is closer to the Sun, it travels faster.

Kepler published his third law later, in 1619 as the square of a planet's orbital period is proportional to the cube of the length of the semi-major axis of its orbit.

Sir Isaac Newton (1642-1726) showed in his masterpiece Philosophica Naturalis Principia Mathematica, which he published in 1687, that relationships in Kepler's laws would apply in the Solar System because of his own laws of motion and the law of universal gravitation. Due to Kepler's second law of equal areas, velocity is also a function of its position on the orbit. The satellite travels faster when it is closer to the central body and slower when it is further away, sweeping equal areas for the same time formulated as in (1.9).

### Generalization of the Energy Conservation Based Derivation of the Concept Under Constant Mass Assumption

The concept given in [1] is based on energy conservation law for circular orbits having constant mass during descend. In this section this is generalized for elliptical orbits, again for constant mass assumption. In the following section, this will be also extended for energy conservation law variable mass showing major, unexpected differences with this assumption.

Total energy TE of the satellite becomes to sum of kinetic energy KE and PE as,

$$TE = \frac{1}{2} {mv}^{2} - G \frac{mM}{r} \qquad ( 2.3 )$$

Where r in our case is the distance between the center of the earth and the satellite at the elliptical orbit, which varies depending on its position in the elliptical orbit. As can be seen the potential PE and kinetic KE energies of a satellite are both a function of its location in orbit, but the total energy TE is a constant as given in (2.1). Substituting position dependent velocity v(r) as given in (1.8) in (2.3) gives,

$$TE = \frac{1}{2} GmM ( \frac{2}{r} - \frac{1}{a} ) - G \frac{mM}{r} \qquad ( 2.4 )$$

Where a is the semi-major axis of the elliptical orbit, which is the simple proof of (2.1).

$$T E = GmM ( \frac{1}{r} - \frac{1}{2 a} - \frac{1}{r} ) = - G \frac{Mm}{2 a} \qquad ( 2.5 )$$

As can be seen this relation is very similar to the formulation as given in [1]. The problem of finding the distance rₕ from the central body, which is the center of the Earth in this case, giving potential energy equal to the total energy as derived in (2.5) simply becomes,

$${r}_{h} = {r}_{0} = 2 a = 2 {a}_{ORBIT} \qquad ( 2.6 )$$

Since a is the semi-major axis of the elliptical orbit, it may alternatively be expressed as a_{ORBIT}, but for simplicity the term 2a is generally used herein. The formulation given in [1], where the distance between the center of the Earth and the satellite is defined as distance r₀, and the potential energy of the satellite becomes equal to the total energy in the circular orbit when,

$${r}_{0} = 2 {r}_{ORBIT} \qquad ( 2.7 )$$

In the relation (2.6) a_{ORBIT} (or simply a) becomes the replacement of r_{ORBIT}, which was the terminology used in [1], and rₕ replaces r₀.

To use the same formalism given in [1], the distance rₕ from the central body where the satellite starts its descent towards to Earth to get into the desired elliptical orbit can be defined with the bounds,

$${r}_{h} = {s}_{f} \cdot a where 1.1 < {s}_{f} < 2 \qquad ( 2.8 )$$

Altitude h_{CLIMB} of a point which has a distance rₕ from the center of the earth is given by,

$${h}_{CLIMB} = {r}_{h} - {r}_{EARTH} \qquad ( 2.9 )$$

Since (2.8) gives the distance from the center of the earth, climb altitude can simply be calculated as,

$${h}_{CLIMB} = {s}_{F} a - {r}_{EARTH} \qquad ( 2.1 )$$

For a circular orbit the climb altitude expressed in S_{F} and orbital altitude h_{ORBIT} can be given as,

$${\dot{h}}_{CLIMB} ( {s}_{F} , {h}_{ORBIT} ) = {s}_{F} ( {r}_{EARTH} + {h}_{ORBIT} ) - {r}_{EARTH} \qquad ( 2.11 )$$

Which leads to a more convenient form given as,

$${h}_{CLIMB} ( {s}_{F} , {h}_{ORBIT} ) = ( {s}_{F} - 1 ) {r}_{EARTH} + {s}_{F} {h}_{ORBIT} \qquad ( 2.12 )$$

### Energy Conservation Formulations for Change of Mass During Descent

The previous derivations here and in [1] were done by assuming the mass denoted as m is constant in the entire descent to orbit. As summarized earlier during the descent, the descent stage rocket is typically activated twice. The first rocket burn is to bring the descent stage with its orbital payload from rₕ towards the orbital injection point (OIP) on the stable orbit. There are basically 2 different strategies of doing this first rocket burn, which both are explained in detail in this work, which consumes most of the decent stage propellant.

The second descent stage rocket is activated in the vicinity of the targeted stable orbit such that its descent trajectory becomes tangent to the desired orbital trajectory and gives the same orbital velocity vector when it reaches the orbital injection point (OIP). This second rocket burn can be viewed as the “fine tuning of the velocity vector” done in the vicinity of the orbital injection point. This maneuver also consumes propellant, but it is far less than the first rocket burn during the descent. At this moment the decent stage is in the desired stable orbit and has a mass of m_{ORBIT}, which includes its orbital payload (satellite) m attached to it by clamps or bolts which can be released by a “separation system”. The last remaining action is commonly known as “separation”, which is the separation of the orbital payload (satellite) m employing one of the conventional separation methods used since 1957, like spring mechanisms, small thrusters, pyrotechnic devices or pneumatic actuators. Activating “separation system” employing pyrotechnic cutters or non-pyrotechnic devices practically will not change the mass of the overall system and will separate the satellite from the remaining part of the decent stage which contains the descent stage rocket, its depleted propellant tank and the auxiliary mass needed for guidance and control, having a total mass of m_{DEC}.

As a result of these two rocket burns at two different times during the descend, the orbital mass m_{ORBIT} is less than the mass m_{O}, the mass of the descent stage, satellite, and propellant at its peak distance away from the center of the earth, which is coined as the “first height” (rₕ) in this work. This mass difference is basically equal to the total amount of consumed propellant mass m_{PROP} in the entire descent which is taken into consideration in deriving the new energy balance equations starting from relation (2.13).

Therefore, the initial descend stage mass m₀, at the peak point of its ascent trajectory rₕ, can be written as,

$${m}_{0} = ( m + {m}_{DEC} ) + {m}_{PROP} = {m}_{ORBIT} + {m}_{PROP} > {m}_{ORBIT} \qquad ( 2.13 )$$

Where m_{DEC} in (2.13) is the mass of the descent stage rocket including rocket motors, empty propellant tank and auxiliary mass need for guidance, excluding the mass of the satellite m, and m_{PROP} is the propellant mass consumed when the rocket thrust is generated during descent. As a result, as shown in (2.13) the mass m₀ at rₕ is greater than the orbiting mass m_{ORBIT}.

As a result of (2.13) this invention concerns propelling a mass m₀>m_{ORBIT}, to a greater distance rₕ>a_{ORBIT} (or rₕ>r_{ORBIT} for a circular orbit) from the center of the Earth and bringing it back to an elliptical orbit having its semi-major axes of with orbit a_{ORBIT} (or rₕ>r_{ORBIT} for a circular orbit). It is claimed that this can result in significant propellant mass saving in putting a mass of m_{ORBIT} into an elliptical orbit having its semi-major axes of with orbit a_{ORBIT} (or rₕ>r_{ORBIT} for a circular orbit) compared to launching to the desired orbits directly even with some other important advantages. This very counter intuitive idea originates from the energy conservation law in an inverse square law gravitational field and is supported with exact numerical simulations of the solution of equation of motion, performed for all available cases.

The solution of the Tsiolkovsky Rocket Equation for no external forces gives the relation between the gained velocity Δv, between the initial and final mass of the rocket as,

$$Δ v = {v}_{e} ln ( \frac{{m}_{0}}{{m}_{f}} ) = {I}_{SP} {g}_{0} ln ( \frac{{m}_{0}}{{m}_{f}} ) \qquad ( 2.14 )$$

Where m_{O} and m_{f} are the initial and final mass of the descent stage before and after the impulsive rocket thrust is assumed to happen instantaneously while remaining stationary during the rocket burn under no external forces, which are the assumptions used in deriving the impulsive solution of the Tsiolkovsky Rocket Equation. The remaining terms in (2.14) which are vₑ, Δv, I_{SP} and g₀ are the velocity of the rocket exhaust with respect to the rocket, change in the velocity resulting from the impulsive burn, specific impulse, and gravitational acceleration at the surface of the Earth respectively.

In a perpendicular launch, when the descend stage trajectory reaches its peak at rₕ, its velocity and kinetic energy becomes zero. Therefore, when the rocket thrust is applied towards the orbital injection point, Δv in (2.14) becomes its velocity v and can be written as,

$$v = {v}_{e} ln ( \frac{{m}_{ORBIT} + {m}_{PROP}}{{m}_{ORBIT}} ) \qquad ( 2.15 )$$

Assuming all the propellant mass m_{PROP} is consumed, then the remaining mass at the velocity gained at v will be m_{ORBIT} at that point due to the relation (2.13). Writing the energy conservation law with 2 different masses gives at rₕ and at orbit becomes,

$$\frac{1}{2} {m}_{ORBIT} {v}^{2} - G \frac{{Mm}_{0}}{{r}_{h}} = - G \frac{{Mm}_{ORBIT}}{2 a} \qquad ( 2.16 )$$

Where M is the mass of the Earth. In (2.16) the left-hand side is the total energy TE after the rocket thrust applied at rₕ and right-hand side is the total energy of m_{ORBIT} in an elliptical orbit as given in (2.5). Substituting (2.15) in (2.16) gives,

$$\frac{1}{2} {{m}_{ORBIT} [ {v}_{e} ln ( \frac{{m}_{0}}{{m}_{ORBIT}} ) ]}^{2} - G \frac{{Mm}_{0}}{{r}_{h}} = - G \frac{{Mm}_{ORBIT}}{2 a} \qquad ( 2.17 )$$

Manipulating (2.17) gives,

$$G \frac{{Mm}_{0}}{{r}_{h}} = \frac{1}{2} {{m}_{ORBIT} [ {v}_{e} ln ( \frac{{m}_{0}}{{m}_{ORBIT}} ) ]}^{2} + G \frac{{Mm}_{ORBIT}}{2 a} \qquad ( 2.18 )$$

Dividing both sides by m_{ORBIT} gives,

$$G \frac{M {m}_{0}}{{r}_{h} {m}_{ORBIT}} = {\frac{1}{2} [ {v}_{e} ln ( \frac{{m}_{0}}{{m}_{ORBIT}} ) ]}^{2} + G \frac{M}{2 a} \qquad ( 2.19 )$$

Since m₀=m_{ORBIT}+m_{PROP} as given in (2.13), dividing both sides of (2.13) by m_{ORBIT} gives,

$$\frac{{m}_{0}}{{m}_{ORBIT}} = ( 1 + \frac{{m}_{PROP}}{{m}_{ORBIT}} ) \qquad ( 2.2 )$$

Substituting (2.20) in (2.19) gives,

$$G \frac{M ( 1 + \frac{{m}_{PROP}}{{m}_{ORBIT}} )}{{r}_{h}} = {\frac{1}{2} [ {v}_{e} ln ( 1 + \frac{{m}_{PROP}}{{m}_{O RBIT}} ) ]}^{2} + G \frac{M}{2 a} \qquad ( 2.21 )$$

With arithmetic (2.21) becomes,

$$\frac{1}{{r}_{h}} = {\frac{1}{2 G M} [ {v}_{e} ln ( 1 + \frac{{m}_{PROP}}{{m}_{ORBIT}} ) ]}^{2} + \frac{1}{2 a} \qquad ( 2.22 )$$

Finally giving,

$${r}_{h} = \frac{1}{{\frac{1}{2 GM} [ {v}_{e} ln ( 1 + \frac{{m}_{PROP}}{{m}_{ORBIT}} ) ]}^{2} + \frac{1}{2 a}} \qquad ( 2.23 )$$

The relation (2.23) looks complex, but since the natural logarithm term in the denominator for m_{PROP}=0 becomes zero, it simply gives,

$${γ}_{h} = 2 a for {m}_{PROP} = 0 \qquad ( 2.24 )$$

Giving the same result for the constant mass derivation, gives the key conclusion of rₕ it must be less than 2a and is a function of the ratio between m_{PROP} and m_{ORBIT} written as,

$${γ}_{h} = f ( {m}_{RAT} ) < 2 a \qquad ( 2.25 )$$

Relation (2.25) for circular orbits become,

$${r}_{h} = f ( {m}_{RAT} ) < 2 {r}_{ORBIT} \qquad ( 2.26 )$$

$${m}_{R A T} = \frac{{m}_{PROP}}{{m}_{ORBIT}} \qquad ( 2.27 )$$

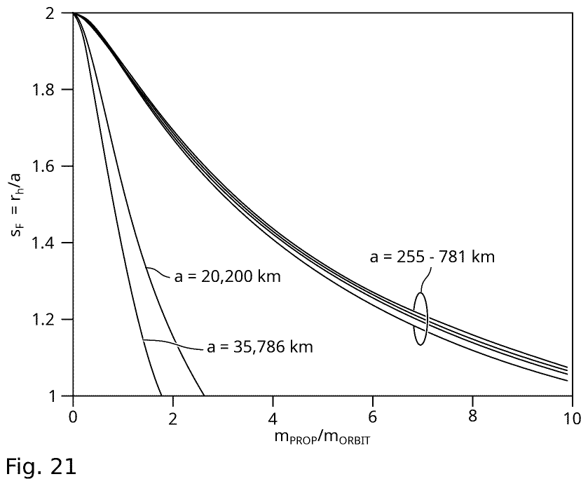

FIG. 21 depicts rₕ/a as a function of s_{f} for orbital altitudes of 255 km, 400 km, 540 km, 781 km, 20,200 km, and 35,786 km, for vₑ=3,000 [m/s]. As can be seen all the curves in FIG. 21 start from 2 which corresponds to m_{PROP}=0 and rₕ=2a condition and all decrease as m_{RAT} increases which is very accepted physical result for every condition.

Although the derivation does not have any equation of motion solutions in inverse square law gravitational field done for this derivation, its results are surprisingly close to full simulations in all orbital simulations in predicting the optimal rₕ₁ for maximum propellant mass savings.

### Energy Efficient Orbital Plane Change Maneuver

Orbital changes consume energy and for many reasons there are several types of other commonly used orbital configurations mechanics that shouldn't be confused with the methods explained herein. The most energy efficient orbital transfer maneuver known has been derived by a German engineer Walter Hohmann in his book published in 1925 [3-6]. It is based on two-impulse maneuvers for transferring between two coplanar circular orbits sharing a common focus. The total Δv requirement is calculated using the Tsiolkovsky rocket equation, which is covered extensively for many cases in U.S. Pat. No. 12,172,774 B1. There are also “Bielliptic Hohmann Transfer” and “Phasing Maneuvers”, “Non-Hohmann Transfers with Apse Line”, “Apse Line Rotation” and “Plane Change Maneuvers” which are all commonly used maneuvers and are very clearly explained in detail in many sources in the references [3-6].

Today it is common practice to solve the equation of motion using numerical methods instead of the impulse based simplified solution named “non-impulsive orbital maneuvers” as done herein. All these classical maneuvers are between 2 orbits, and it is the goal of the method described herein to “land” on a desired orbit from a distance rₕ a radial distance defined from the center of the Earth.

For launch safety reasons, after the rocket leaves the launch pad and gets higher than a specified height and picks some vertical speed, the rocket must make a departure from the vertical in a specified azimuth angle to reach a desired orbital inclination angle and follow a pitch over maneuver to intersect its desired orbit, basically known as gravity turn, which can be traced back to one of the Hermann Oberth's contributions in 1920's to the rocket science [1, 6]. This is also known as zero attack angle trajectory. The rocket launch azimuths (the angles that define the direction of a rocket's trajectory) must be cleared by agencies such as the Federal Aviation Administration (FAA), U.S. Department of Defense (DoD), National Aeronautics and Space Administration (NASA), National Oceanic and Atmospheric Administration (NOAA) and in some cases even the U.S. Coast Guard and range authorities if the launch is performed from a military site, mainly for safety reasons.

Inclination angle i of a satellite orbit, is related to the latitude of the launch site θ and the launch azimuth A with a simple formula given as,

$$Cos ( i ) = Sin ( A ) \cdot Cos ( θ ) \qquad ( 3.1 )$$

This relation puts limits on the inclination angle for the satellite orbit launched from any site. As an example, all launches from Cape Canaveral in central Florida (latitude θ=28.4° North) are only permitted the launch azimuth angle limits of 35°-120°, giving the corresponding inclination angle limits of 57°-39°. Similarly, all launches from Vandenberg Space Force Base in California (latitude θ=34.7° North) are only permitted the launch azimuth angle limits of 140°-201°, giving the corresponding inclination angle limits of 56°-104°. Therefore, one cannot launch a satellite to a polar orbit from Cape Canaveral directly, but a direct polar orbital launch is possible from Vandenberg Space Force Base in California. The orbital inclination angle formula (3.1) also implies that orbital inclination angles lower than the launch site latitude are not possible. Therefore, both Cape Canaveral and Vandenberg Space Force Base launches require energy intensive orbital inclination angle change maneuvers for orbits having orbital inclination angles below their latitudes.

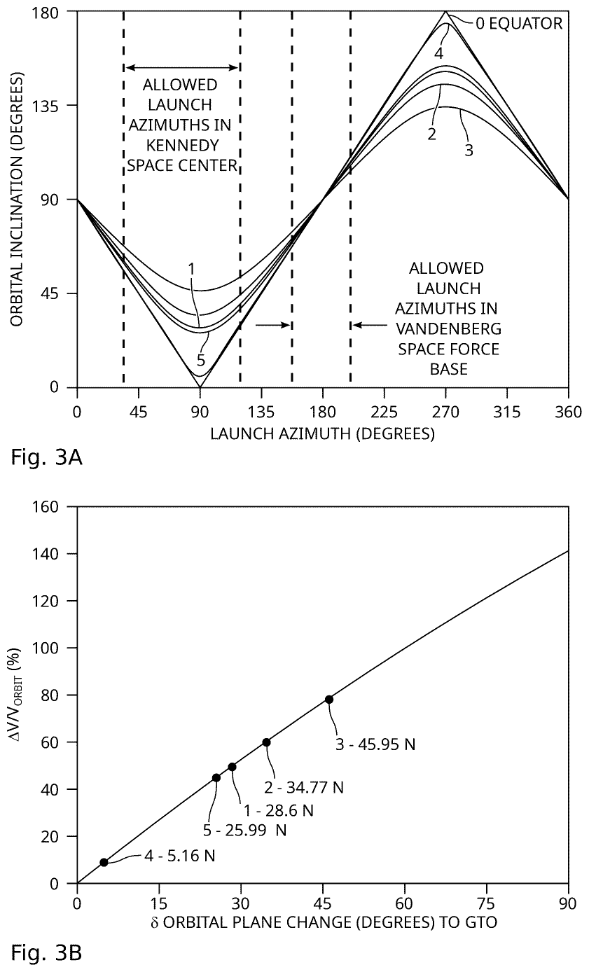

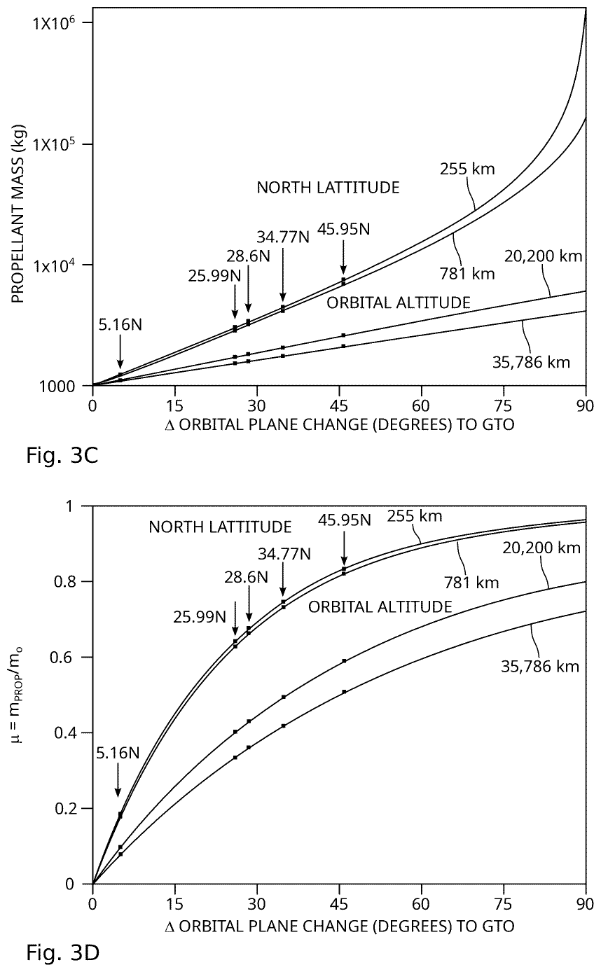

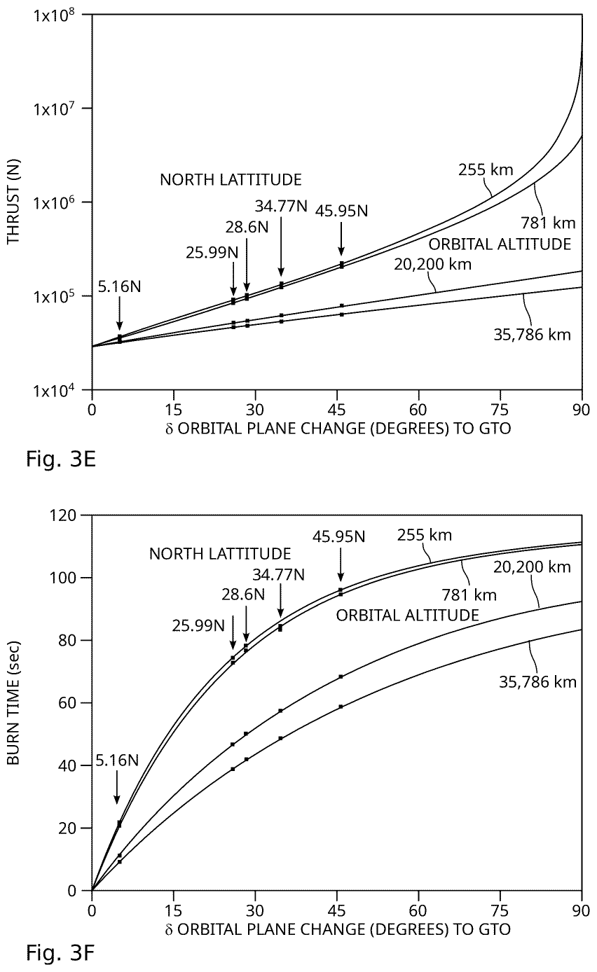

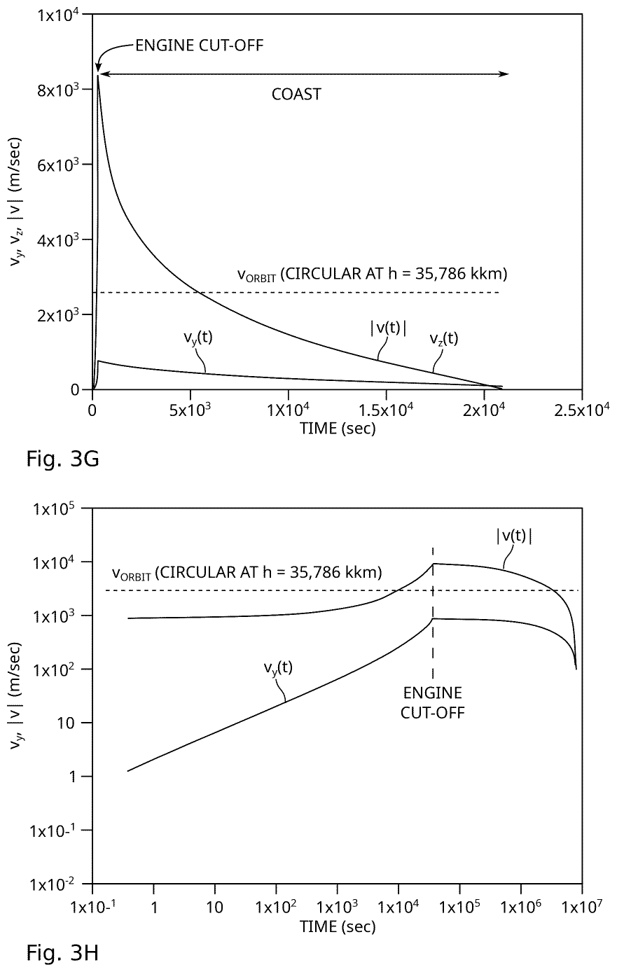

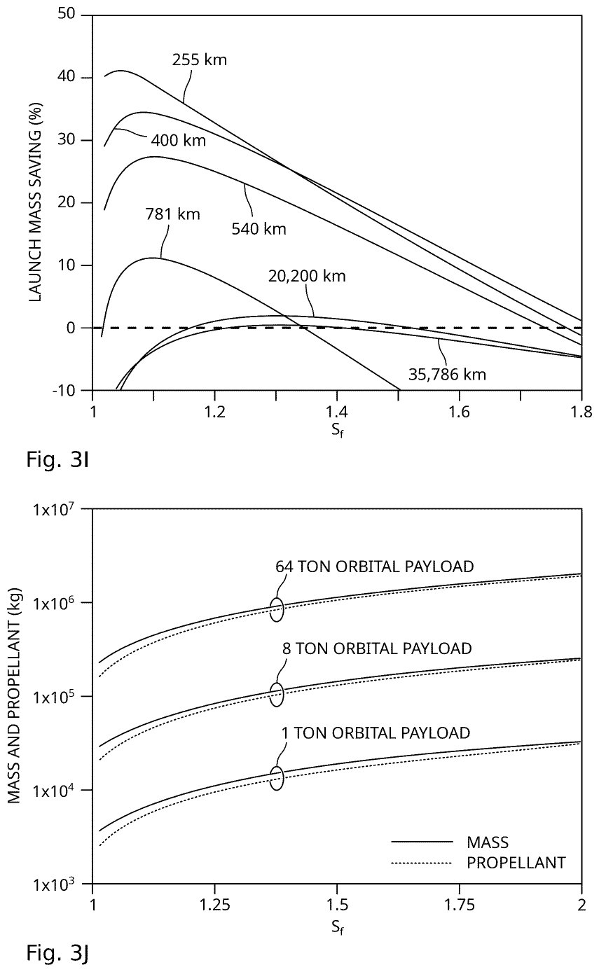

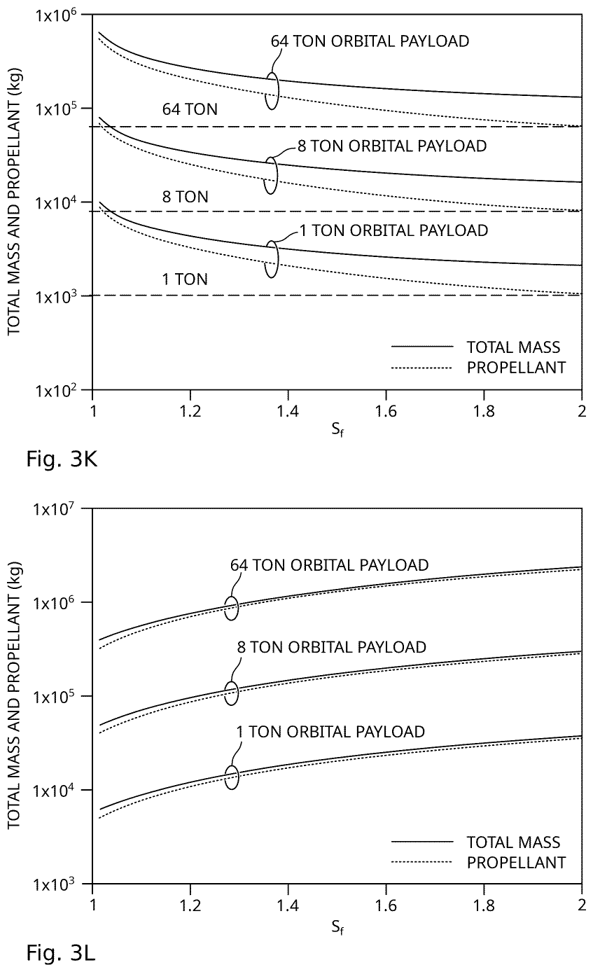

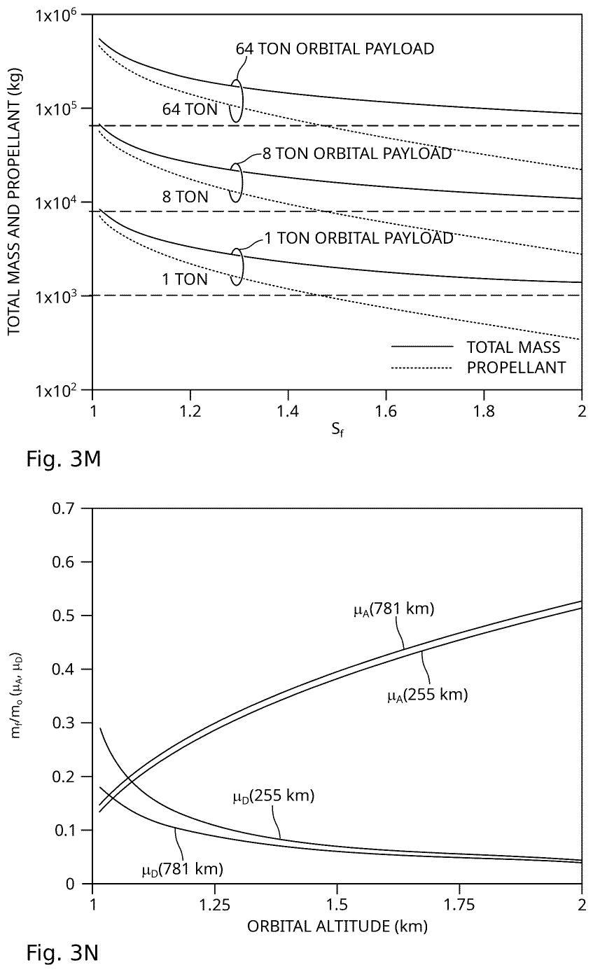

FIG. 3A depicts the relation between the launch azimuth angle and the inclination angle as shown in (3.1) for several launch sites where most space launches are performed, see Table 2.

TABLE 2

| FIG. 3A | | | Operational |
|---|---|---|---|
| reference | Launch Site | Latitude | Since |
| 1 | Kennedy Space Center, FL, USA | 28.60N | 1962 |
| 2 | Vandenberg Space Force Base, CA, USA | 34.77N | 1958 |
| 3 | Baikonur Cosmodrome, Russian Federation-Kazakhstan | 45.95N | 1955 |
| 4 | ESA Space Center, Kourou, French Guiana | 5.16N | 1964 |
| 5 | SpaceX Star Base, Boca Chica, TX, USA | 25.99N | 2018 |

A geosynchronous orbit (GSO) is an orbit in which the satellite orbital period matches the Earth's rotational period. It can be at any orbital inclination with an orbital altitude of 35,786 km. Most communication satellites are in a geostationary orbit (GEO), which is a special case of the geosynchronous orbit having zero inclination and eccentricity. In other words, their orbits are circular equatorial orbits. A satellite in geosynchronous orbit remains at a fixed location for an observer on the Earth giving a great advantage in communication and any kind of satellite broadcasting. However, a “direct” launch to an orbital inclination of zero degrees, or in other words, launching a communication satellite “directly” to a zero-degree orbital inclination is only possible from a launch site located on the Equator. There are 580 GEO satellites in orbit and all 580 of them needed an energy hungry orbital inclination angle change maneuver to put them in geostationary orbit. Unfortunately, one cannot launch a satellite directly to GEO from Cape Canaveral or Vandenberg Space Force Base in California. This limitation is eliminated using the methods claimed herein.

The inclination angle i of an orbit defines an orbital plane with an angle given by the inclination angle i with respect to equatorial plane. Therefore, a change in the inclination angle of an orbit requires an orbital plane change, which is referred to as an “Orbital Plane Change Maneuver”. This maneuver requires putting the satellite into the closest inclination angle possible to the desired orbit, and then a change in the orbital velocity vector at the orbital nodes at the expense of additional propellant. Since the satellite is already in an orbit, it already has a very large orbital velocity, and trying to change the direction of this vector quantity by applying a thrust translates to consuming propellant and fuel or mass loss term Δm, clearly seen in the impulsive solution of the Tsiolkovsky Rocket equation [1-6]. The larger the angle δ between the two orbital planes, the more expensive the maneuver is, which can be easily seen in vector sum diagrams even for the orbits having the same angular momentums [2-6]. For this case, known as “Pure Rotation”, the required Δv that must be provided by the rocket thrust can be given as,

$$Δ v = 2 v Sin ( \frac{δ}{2} ) \qquad ( 3.2 )$$

Where v is the orbital velocity magnitude or the speeds in both orbits at different planes defined by the different inclination angles, which is assumed to be the same velocities for this simplest case. As an example, applying formula (3.2) for a 60° orbital plane change maneuver requires a Δv of velocity change equal to the speed of the spacecraft itself, which is equal to its orbital speed [2-6].

FIG. 3B depicts the percentage of velocity change as given in (3.2) as a function of orbital plane change, with markings for the 5 launch sites given in Table 2. As can be seen in the figure, launching a communication satellite to GEO from the ESA Space Center, located in Kourou, French Guiana, very close to Equator, is clearly advantageous over other launch sites.

Orbital plane change maneuvers between orbits with different orbitals speeds require even more complex formulations, and several different approaches can be taken, but in any case, they consume more propellant than the formulation given by (3.2).

To calculate how much propellant is needed to gain a given Δv in (3.2), it can be approximated by the solution of the Tsiolkovsky Rocket Equation [1-6] given as,

$${F}_{EXT} = m \frac{d v}{dt} + {v}_{e} \frac{d m}{dt} \qquad ( 3.3 )$$

Where F_{EXT}, m, v, vₑ are sum of external forces, mass, velocity, and velocity of the rocket exhaust with respect to the rocket. Under the assumption of no external forces F_{EXT} present (3.3) becomes,

$$m \frac{d v}{dt} = - {v}_{e} \frac{d m}{dt} \qquad ( 3.4 )$$

Rearranging equation (3.4) simply gives,

$$d v = - {v}_{e} \frac{d m}{m} \qquad ( 3.5 )$$

The classical solution of the Tsiolkovsky Rocket Equation [1-6] with the use of natural logarithm [1, 3-6] becomes,

$$Δ v = {v}_{e} ln ( \frac{{m}_{0}}{{m}_{f}} ) = {I}_{S P} {g}_{0} ln ( \frac{{m}_{0}}{{m}_{f}} ) \qquad ( 3.6 )$$

Where m₀, m, vₑ, g₀, and I_{SP} are the initial mass of the rocket before the maneuver, final mass of the rocket after consuming its propellant, rocket exhaust gas velocity with respect to the rocket, gravitational acceleration at sea level, and specific impulse respectively. m_{f} can be thought of as the orbital mass in our case which includes the propulsion unit as well. Since the difference in mass Δm, is the propellant mass consumed represented by m_{PROP} in this variable mass system, the following relations also apply,

$$Δ m = {m}_{PROP} = {m}_{0} - {m}_{f} \qquad ( 3.7 )$$

$$or$$

$$Δ m = {m}_{f} + {m}_{PROP} \qquad ( 3.8 )$$

Substituting (3.7) and (3.8) in (3.6) another forms of (3.6), can be derived which is known as the “impulsive solution” and is given by,

$$\frac{Δ m}{{m}_{0}} = 1 - {e}^{- \frac{Δ v}{{v}_{e}}} = 1 - {e}^{- \frac{Δ ν}{{g}_{0} {I}_{S P}}} \qquad ( 3.9 )$$

Relation (3.9) can be written in terms of m₀ and m_{PROP} as,

$$Δ m = {m}_{PROP} = {m}_{0} ( 1 - {e}^{- \frac{Δ ν}{{ν}_{e}}} ) \qquad ( 3.1 )$$

Or in terms of m_{f} and m_{PROP} as,

$$Δ m = {m}_{P R O P} = {m}_{f} ( {e}^{\frac{Δ v}{{v}_{e}}} - 1 ) \qquad ( 3.11 )$$

FIG. 3C depicts the amount of extra propellant (mass) that must be burned to achieve the orbital plane change, for a satellite with a 1 ton of orbital payload mass to GTO orbit as a function of orbital plane change, with markings for each launch site in Table 2 and the orbital radii given in Table 1. Orbital plane change maneuvers are not only done for GTO orbits, as it is also a very common practice to perform them in LEO (Low Earth Orbit) as well. As an example, a LEO Polar orbital launch directly from Cape Kennedy due to azimuth launch restrictions (for safety reasons) is not possible. Therefore, a conventional launch is done with the maximum inclination angle possible at any location and then an orbital inclination plane change maneuver is performed.

FIGS. 3D-3F depict the calculated propellant, thrust, and related burn times with a constant burn rate for orbital plane change maneuvers at the orbital altitudes of 255 kilometers (km), 781 km, 20,200 km, and 35,786 km with a 1 ton orbital payload to GTO as a function of orbital plane change, with markings for each launch site listed in Table 2 and the orbital radii listed in Table 1. As can be seen, orbital plane change maneuvers, even if only rotational, are very costly and any method that can minimize this is a very valuable improvement in the orbital launch business. The Space Shuttle, for example, was capable of a plane change maneuver of only 3°, which was an expensive exhaust of its propellant capacity. Using the methods disclosed herein, the launch azimuth restrictions associated with any particular launch site can be overcome.

Two types of very propellant efficient orbital plane change maneuvers are permitted, as given below:

### Launching to an Orbit Having an Inclination Angle not Conventionally Possible Due to Launch Azimuth Restrictions

A good example is launching to a polar orbit from Cape Kennedy Space center. Although formula (3.1) allows for a polar orbit launch from that latitude, due to launch azimuth restrictions, it is not possible to launch to a polar orbit with the given launch azimuth limits as can be seen in FIG. 3A. The same is true from Boca Chica, TX. In this case the rocket launches from a launch pad at latitude θ with any launch azimuth allowed at that site, and when it reaches its peak at rₕ, let its latitude be δ(rₕ) and longitude be φ(rₕ). The only condition imposed is that the latitude θ(rₕ)<i, which is a very easy condition to satisfy. After the large boost stage is separated, the remaining descent stage consists of a rocket propulsion system, its propellant needed for the descent maneuvers, and the satellite or orbital payload. At that point it will have almost zero kinetic energy (i.e., zero kinetic energy if it was launched vertically). To demonstrate this case all the simulations herein are performed launching the rocket vertical until it reaches an altitude h_{L}, and then keeping the thrust steady with 5° angle from the vertical.

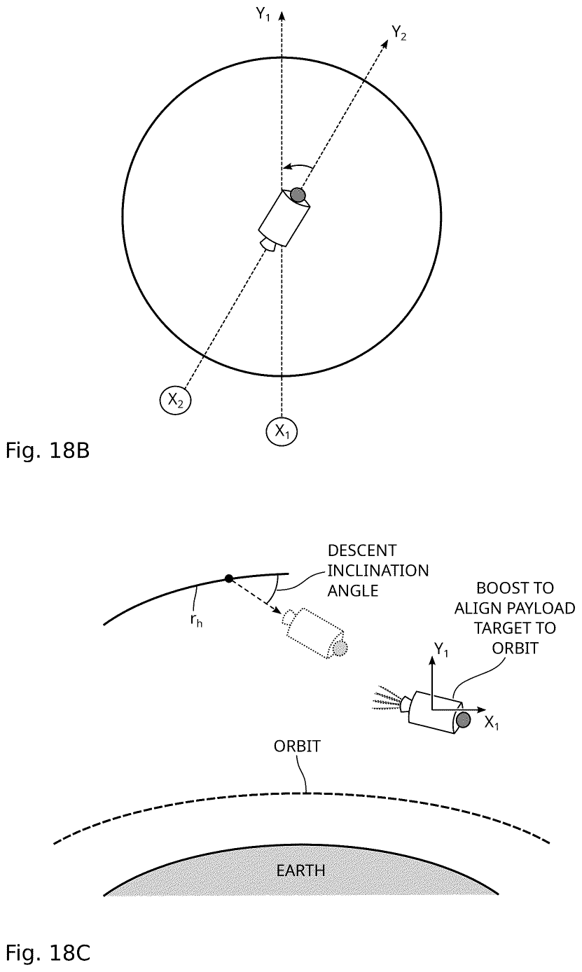

FIGS. 3G and 3H are linear and logarithmic plots, respectively, depicting the magnitude of the ascent velocity vector |v(t)| and its velocity component v_{y}(t) in the direction along its trajectory for an elliptical orbit with a perigee of 35,786 km, where rₕ=1.2a (s_{f}=1.2). For every case where vₓ(t)=0 its radial component is zero. As can be seen these velocities are in the order of hundred [m/s], much smaller than the orbital velocities which are in the order of several thousand [m/s]. Therefore, rotating the descent stage towards any direction around its axes at the peak point to any azimuth angle gives an orbit with the desired inclination angle, requiring a very small amount of energy compared to standard orbital plane change maneuvers as shown in FIGS. 3B-3F and conceptually shown in FIG. 18B. The rotation can be started during the boost phase with a retro thrust at the peak, after reaching the peak, or simultaneously rotating while ascending—all are possible and very low energy maneuvers compared to the standard orbital plane change maneuvers.

The figures depict a vertical lift-off followed by a 5 degree angle of constant powered ascent, shown respectively in linear and logarithmic scale. With the help of (3.1) and some very basic heading formulas based on navigational routines one can easily calculate which descent azimuth angle is needed to reach the desired orbital inclination angle, but the orbital inclination angle still cannot be lower than the latitude θ(rₕ). As can be seen, this maneuver has different ascent and descent trajectory planes.

ii) Launching to an Orbit Having Inclination Angle that is not Possible to Reach from a Launch Point Latitude

The origin of this problem is that the maximum value of the Cosine function for any angle cannot exceed 1, therefore one can't launch to an orbital inclination angle below its latitude, which is clearly seen as a result of relation (3.1). Taking a real example of launching to an equatorial orbit from Cape Kennedy requires an orbital change maneuver 28.6 degrees, due to the fact that lowest inclination angle that can be realized from Cape Kennedy will be its latitude of 28.6 degrees. The solution to this problem is to launch the rocket towards any point convenient on the Equator, which is in the range of allowable launch azimuths. Obviously, the allowed launch azimuth giving the shortest distance to the equatorial intercept gives the smallest energy solution. The latitude of the peak point of the ascent trajectory rₕ should be less than or equal to its desired orbital inclination angle i given as,

$$θ ( {r}_{h} ) = i \qquad ( 3.12 )$$

If (3.12) is set to zero one can launch to any inclination angle, including equatorial orbit. The descent maneuver after this point is the same maneuver as explained above. When the rocket reaches rₕ, it has almost zero kinetic energy, independent of its launch angle to reach the Equator or the latitude equal to its orbital inclination angle i. Since the rocket has almost no kinetic energy at this point, rotating the descent stage to any direction around its axes requires very a small amount of energy. At rₕ it will rotate towards any heading given by navigational calculation using an azimuth angle A. In other words, instead of the massive amounts of energy required to change from an initial launch orbit to a desired orbit using conventional methods, using the methods disclosed herein the rocket simply needs to rotate at the distance rₕ from the center of the Earth before, or shortly after it begins its descent. As can be seen, both of these maneuvers have different ascending and descending trajectory planes.

### Descent Stage Design Methodology

The overall goal is to launch an orbital payload to an elliptical or circular orbit with given orbital parameters. The method explained herein requires launching an orbital payload to a distance larger than a_{ORBTAL} (r_{ORBTAL}, in the case of a circular orbit) from the center of the Earth and performing a descent maneuver using rocket propulsion. This descent maneuver using rocket propulsion requires additional propellant to be launched to a larger distance away from the center of the Earth. Launching a larger payload even to the same distance away from the center of the Earth requires a larger amount of propellant and initial launch mass, as shown in FIGS. 3J and 3L. On the other hand, launching to a greater distance away from the center of the Earth creates a higher potential energy, which can be used for assisting the rocket descent, as shown in FIG. 3K and FIG. 3M. The key rocketry parameter y [1], which shows the ratio of final rocket mass to initial rocket mass for ascent and descent, is shown in FIG. 3N. Therefore, one should expect that there should be an optimum rₕ giving minimum propellant for a given a_{ORBTAL} (r_{ORBTAL}, in the case of a circular orbit) for a given orbital payload. Finding this optimal r_{hOPTIMAL} requires many numerical solutions of equation of motions in an inverse square law gravitational field using different descent strategies, more complex than derived in [7]. One has to find if the propellant and launch mass given by r_{hOPTIMAL} with the method disclosed herein can save propellant and launch mass as compared to the most efficient prior-art launching methods to the same orbital payload to a_{ORBITAL} (r_{ORBITAL}, in the case of a circular orbit) using the gravity turn. This comparative work is done by solving equation of motions in three dimensions for the inverse square law gravitational field with a simulator called “Rocket Designer” and “Orbit Designer”.

For the given orbital mass the “Rocket Designer” software designs a rocket with very primitive inputs like thrust to weight ratio of the rocket at the launch pad, thrust to weight ratio of the rocket engines used, burn rate, thrust, and the k factor, which is a critical parameter relating to propellant mass to the total mass of the booster stages, as explained in [1]. The rocket parameters are fed into the “Orbit Designer” which in simulation launches the rocket into the desired orbit and the total rocket reference mass m_{0REF} and propellant reference mass m_{0PROP} saved as reference value to be compared with the simulation methodology explained in detail in [1].

The following are step-by-step definitions of the descent with one-to-one simulations to quantify the savings of launch and propellant mass. After the launch and the initial stage separation, the descent stage reaches its peak altitude, or in other words, when the distance from the center of the earth is given as,

$${r}_{h} = {s}_{f} \cdot a where 1.1 \leq {s}_{f} \leq 2 \qquad ( 3.13 )$$

After reaching rₕ there are 2 different descent strategies which can be employed, named the “Two Step Strategy” and “Three Step Descent Strategy”. Both approaches are executed in sequence to find the s_{f} giving the minimal propellant and launch mass. These are the basic descent maneuvers having the same ascent and descent planes.

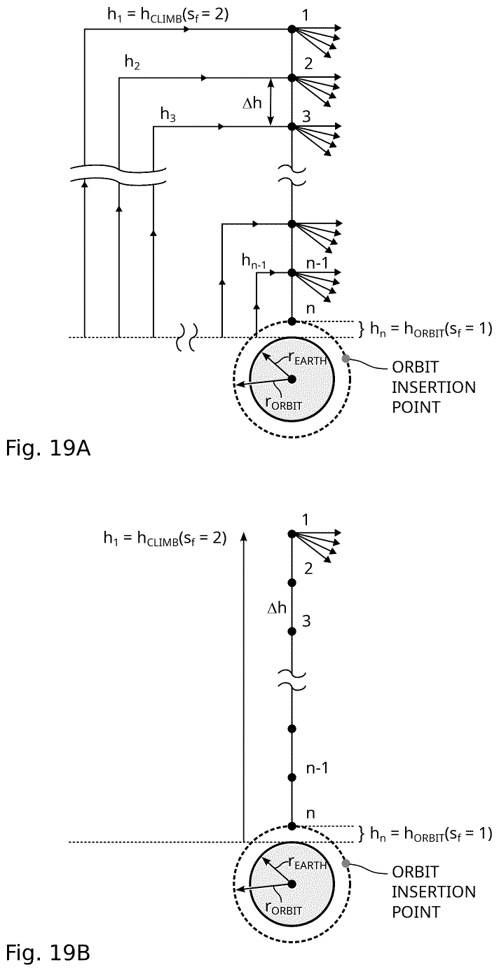

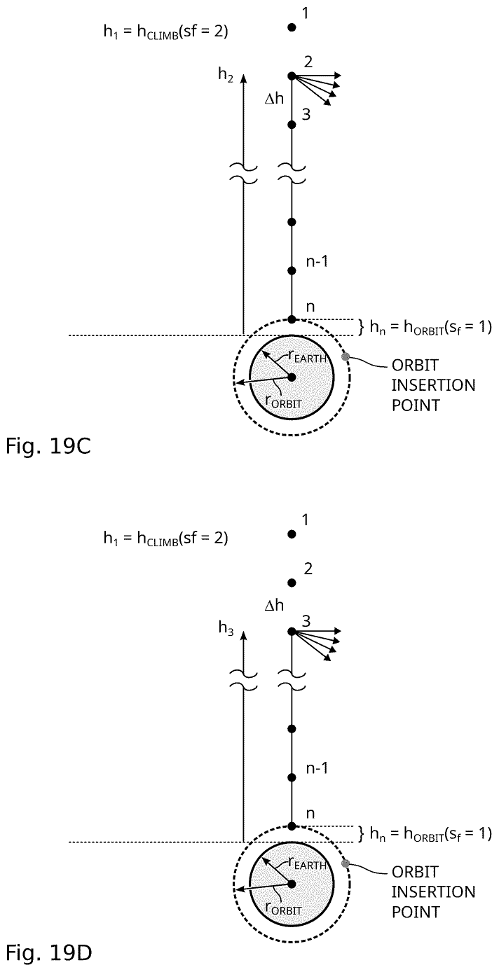

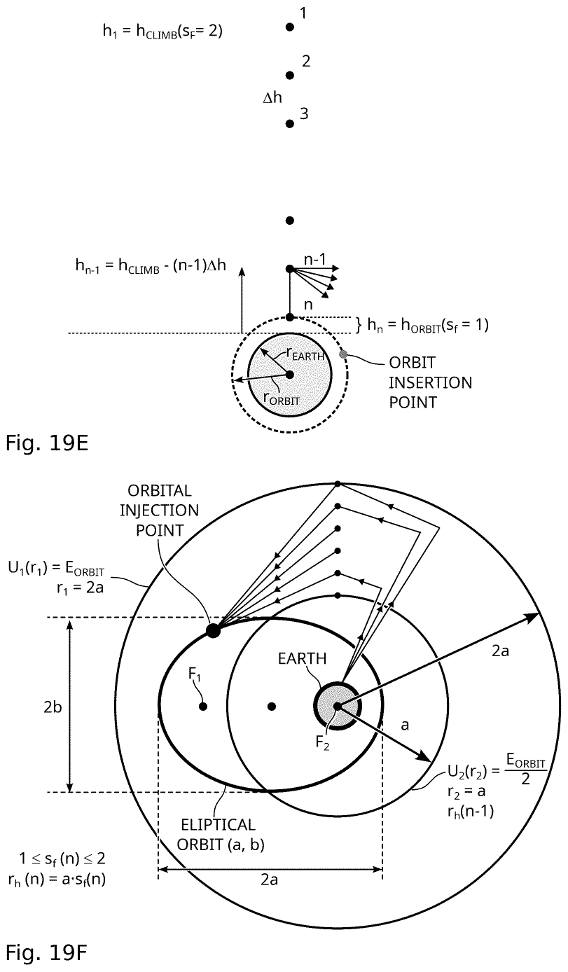

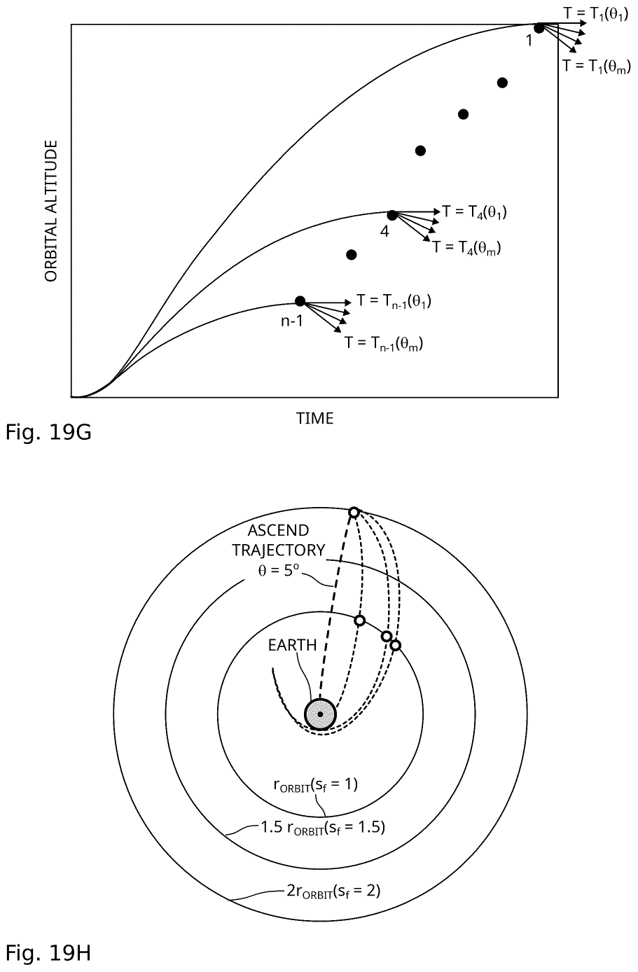

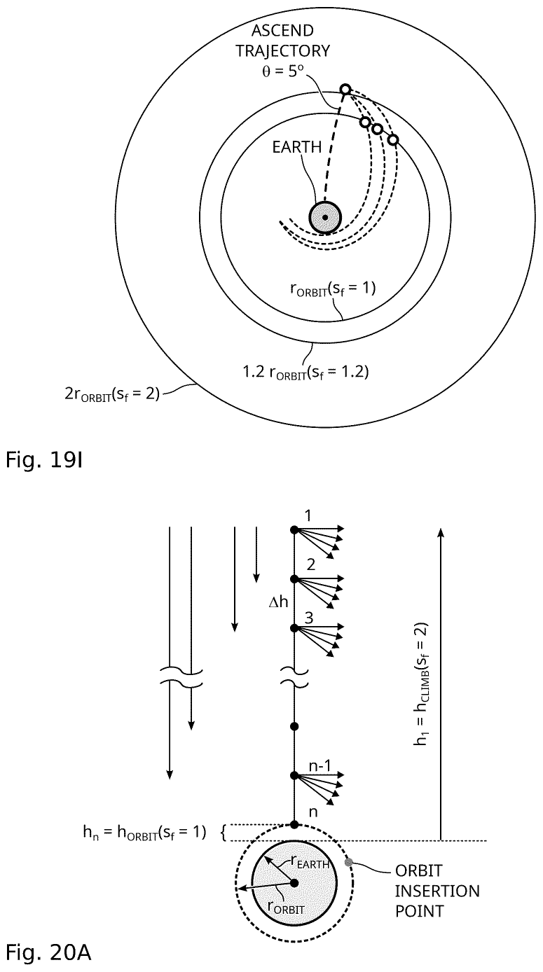

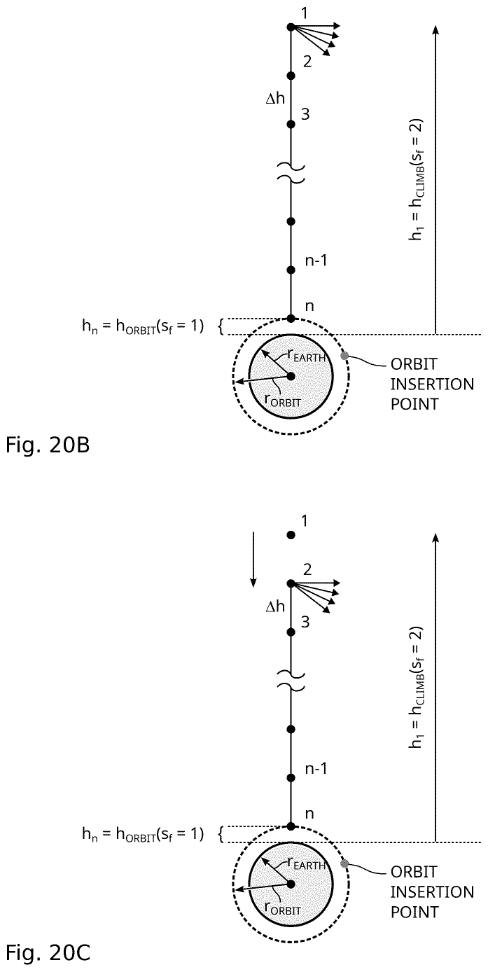

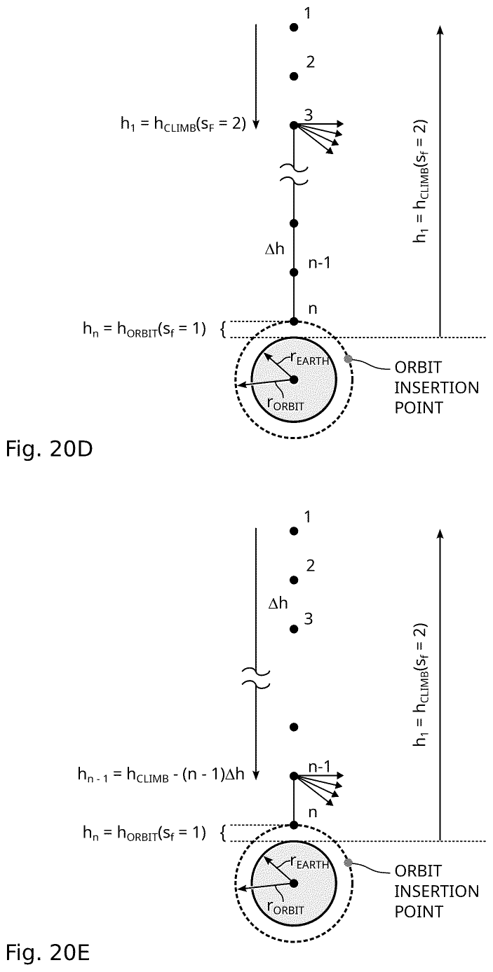

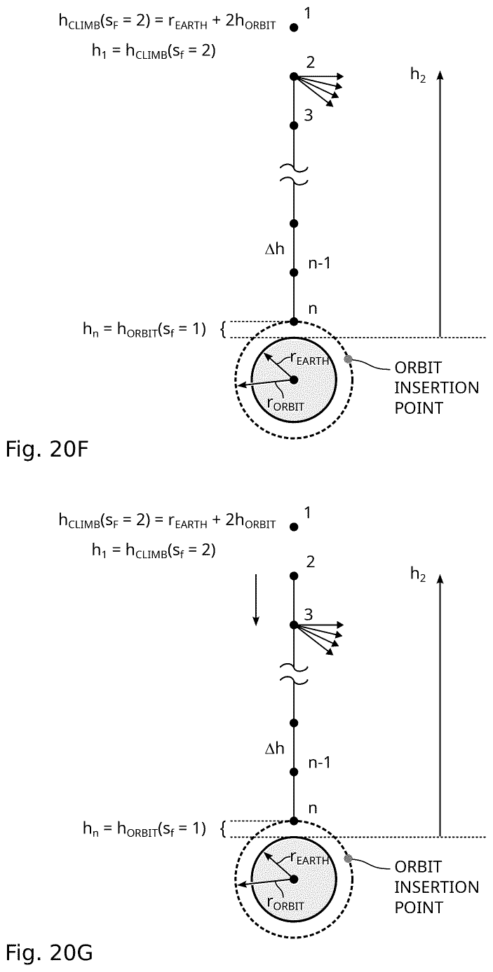

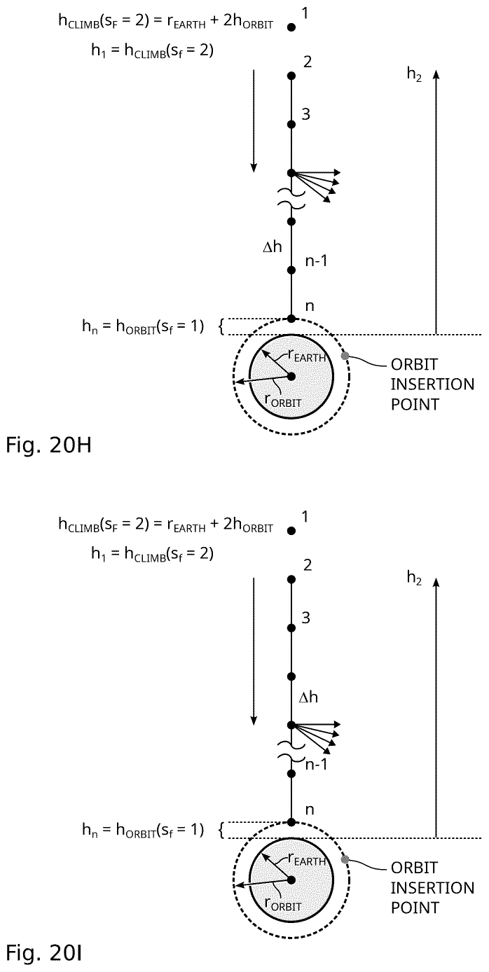

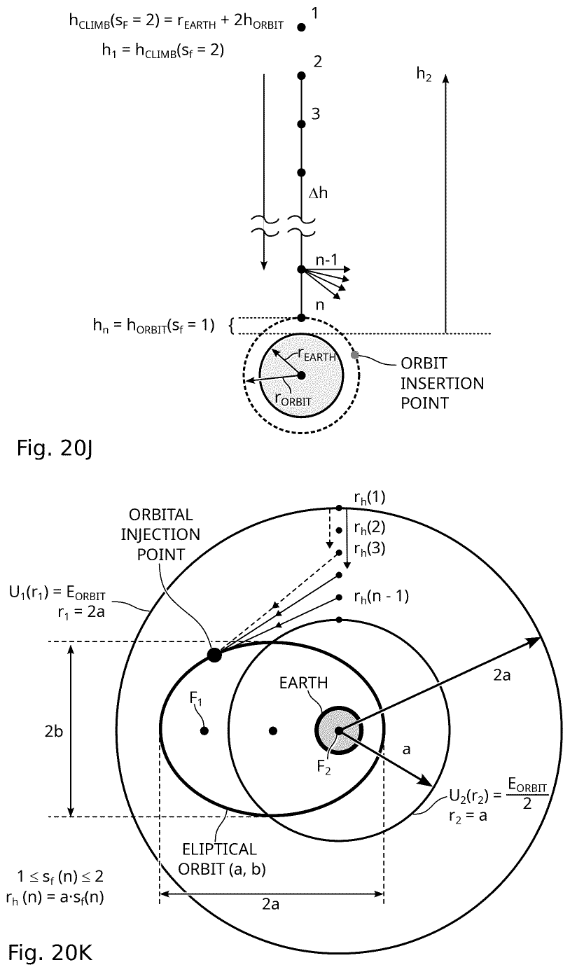

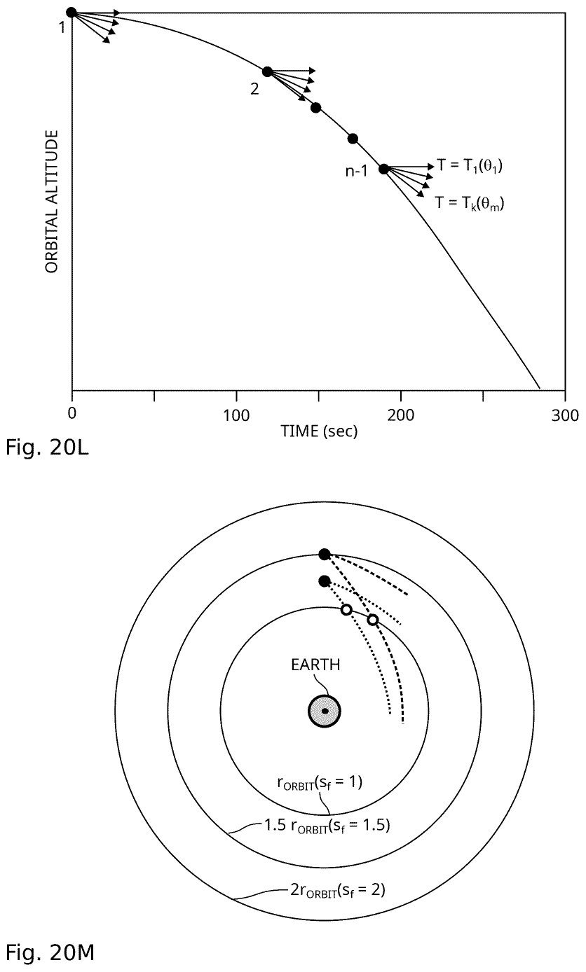

FIGS. 19A through 19I and FIGS. 20A through 20M respectively depict examples of two step and three step descent methods. Both methods generate n sampling points between radial distances r_{hMIN}, corresponding to s_{f}=1 and r_{hMAX} corresponding to s_{f}=2 in (3.13) and as shown in FIG. 19A and FIG. 20A, where n is in the order on 100 or more to construct a smooth curve showing the propellant saving as a function of s_{f} as shown in (3.17). The sampling point index n=1 corresponds to the point corresponding to r_{hMAX} and n being the point corresponding to r_{hMIN} as shown in FIG. 19A and FIG. 20A. The strategy in both methods is to calculate the direction and the duration of the given descend thrust, in other words burn time, from each of the points to land on the desired point on the targeted stable orbital trajectory. This process requires solutions of non-linear equations involving the solution of equation of motion in inverse square gravitational field in three dimensions, using Newton's method for the solution of the non-linear equations involved. This iterative process is depicted conceptually with multi-arrow symbolization as shown in FIG. 19A through FIG. 19E, Fig. and 19G and FIG. 20A through FIG. 20J from m=n−1 points. Details of Newton's method are explained in detail in [1]. Calculating the direction and burn time from all m points to land at the desired point on the targeted stable orbital trajectory is half of the story. As can be seen in the real simulation results shown in FIG. 19H, FIG. 19I, and FIG. 20M, the intersection angle between the descent trajectory and the desired targeted stable orbital trajectory is different for each case. The “fine tuning” burn parameters, which are the time, direction, and duration of the second burn in the vicinity of the orbital injection point has to result in orbital velocity vector of the targeted stable orbital trajectory. As a result, for all m=n−1 points the total propellant mass that must be carried in the descent stage along with the orbital payload is calculated for the given descent stage rocket thrust. The differences in the descent paths come from how the first rocket burns are executed.

### Two Step Descent Strategy: First Rocket Thrust Applied at the Peak Points

This is the very straightforward descent path. The simulations are done for descent stage being launched to each n point having a different altitude from the launch pad. After reaching rₕ the descent stage fires its rocket engines giving thrust in a calculated direction towards the insertion point selected on the desired orbit. The needed burn time and the direction of the descent stage are calculated such that the descent trajectory intersects the targeted orbit below for many s_{f} values in the given range for a given thrust. This calculation is done by solving the equations of motion in an inverse gravitational field with rocket descent parameters n times covering the altitude or radial distance range of,

$$1 \leq {s}_{f} ( n ) \leq 2 \qquad ( 3.14 )$$

As can be seen by substituting s_{f}=1 in (2.9) or (2.10) the minimum value of the climb altitude becomes,

$${h}_{n} = {a}_{ORBIT} - {r}_{EARTH} \qquad ( 3.15 )$$

Similarly, by substituting s_{f}=2 in (2.9) or (2.10) the maximum value of the climb altitude becomes,

$${h}_{1} = 2 {a}_{ORBIT} - {r}_{EARTH} \qquad ( 3.16 )$$

When the descent stage is in close proximity to the insertion point on the orbit, the attitude of the descent stage, thrust, and burn time is calculated again, such that when the final burn is completed, the descent stage becomes tangent to the desired orbit at the desired insertion point with its velocity equal to the orbital velocity when it intersects the desired orbit. When this is satisfied the satellite stays in that orbit with no additional rocket assistance. In other words, the descent stage velocity vector becomes equal to the orbital velocity vector at the insertion point when the burn is completed. All the simulation values are stored and the total mass m₀ and propellant mass m_{PROP} versus s_{f} to take the rocket from the launch pad to rₕ and back down to the desired orbital trajectory using standard gravity are plotted and the percentage mass gain is calculated as,

$$\% {m}_{0 GAIN} ( {s}_{f} ) = 100 \cdot \frac{[ {m}_{0 PROP} - {m}_{0} ( {s}_{f} ) ]}{{m}_{0 PROP}} \qquad ( 3.17 )$$

FIG. 3I depicts the percentage of launch mass savings as a function of S for the orbital altitudes of 400 km, 540 km, 781 km, 20,200 km, and 35,786 km with a one ton payload.

It is especially advantageous to employ the disclosed method for LEO, resulting in great propellant and total mass savings and/or the use of smaller rockets capable of launching the same orbital mass into desired orbits. In this strategy, m=n−1 number of simulations may be needed.

FIGS. 19A through 19F depict the conceptual drawings for a vertical launch. As explained earlier, due to safety reasons the rocket continues its ascend with a small angle, like 5° from the vertical. In that case, the n sampling points are not in the same radial line as shown in FIG. 19G. FIGS. 19H and 19I show the real simulations after the first rocket burn for different s_{f} values at an orbital altitude of 35,786 km, with no “fine tuning” second burn in the vicinity of the targeted stable orbit.

ii) Three Step Descent Strategy: First Rocket Thrust Applied after a Free-Fall from the Peak Height

After reaching rₕ the descent stage rocket is not fired immediately, it is fired at a later time after a targeted free-fall distance is reached in the calculated direction and thrust towards the orbital injection point. The same n sampling points are used as can be seen in the conceptual figures explaining the three step descent strategy shown in FIGS. 20A through 20 FIG. 1. For a simulated altitude corresponding to altitude sampling point m, there will be a free fall to sampling points (m−1), (m−2), (m−3), (m−4), . . . (n−1), and there will be j=m−1 simulation cases, giving total of

$${n}_{simulation} = \frac{( {n}^{2} - n )}{2} \qquad ( 3.18 )$$

simulation cases. As an example, for n=100 altitude sampling points there will be a need of 4,950 simulation cases and minimum propellant will be found.

Similarly, due to safety reasons the rocket continues its ascend with a small angle, like 50 from the vertical. In that case the n sampling points will not be in the same radial line as shown in FIG. 20L. FIG. 20M depicts the real simulations after the first rocket burn for a s_{f} value with an orbital altitude of 35,786 km, with no “fine tuning” second burn in the vicinity of the targeted stable orbit.

Each of the strategies has a different class of descent trajectories and the simulator suggests the one giving the greater m_{PROP} saving.

Typical publicly available orbital launch prices for different missions and major players are presented in Table 3.

TABLE 3

| Operator | Model | LEO $ | LEO MASS | GTO $ | GTO MASS |
|---|---|---|---|---|---|
| SpaceX | Falcon 9 | $ 67,000,000 | 22,800 kg | $ 97,000,000 | 8,300 kg |
| SpaceX | Falcon Heavy | $ 97,000,000 | 63,800 kg | $ 97,000,000 | 26,700 kg |
| ULA | Atlas V | $ 109-153,000,000 | 20,500 kg | $ 150,000,000 | 8,900 kg |
| ULA | Delta IV | $ 350,000,000 | 28,790 kg | $ 350,000,000 | 14,220 kg |
| Ariene Space | Ariene 5 | $ 140-160,000,000 | 21,000 kg | $ 160-190,000,000 | 10,500 kg |
| Ariene Space | Ariene 6 | $ 80-95,000,000 | 21,000 kg | $ 80-95,000,000 | 10,500 kg |
| Roscosmos | Soyuz 2 | $ 50-60,000,000 | 7,800 kg | $ 60-70,000,000 | 3,250 kg |

LEO (Low Earth Orbit) 160-2,000 km Altitude,
GTO (Geostationary Transfer Orbit),
Elliptical Orbit (Altitudes: Perigee 200-1,500 km, Apogee 35,786 km),
GEO (Geostationary Orbit) 37,500 km,
Ariene Space is the European Space Agency,
ULA is a joint Venture between Boeing and Lockheed Martin,
Roscosmos is a Russian Federation Company.

In addition to significant propellant and total launch mass savings, the disclosed method can cut down on the number of total yearly satellite launch missions by 10% for the same number of satellites launched. As an example, published orbital launches in 2024 were 254, one launch every 34 hours. Using a 10% reduction in missions, 25 fewer launches would accrue, resulting a minimum yearly saving of $2,500,000,000.

FIG. 3J depicts the total m₀ and propellant mass m_{PROP} for ascension, launching orbital payloads of 1, 8, and 64 Tons to a target altitude of 255 km with s_{f} in the range of 1≤s_{f}≤2, where s_{f}=rₕ/a_{ORBIT}.

FIG. 3K depicts the total m_{0DESCEND} and propellant mass m_{PROP}_DESCEND in descent with orbital payloads of 1, 8, and 64 Tons to the target altitude of 255 km with s_{f} in the range of 1≤s_{f}≤2, where s_{f}=rₕ/a_{ORBIT}.

FIG. 3L depicts the total m₀ and propellant mass m_{PROP} for ascension, launching orbital payloads of 1, 8, and 64 Tons to a target altitude of 761 km with s_{f} in the range of 1≤s_{f}≤2, where s_{f}=rₕ/a_{ORBIT}.

FIG. 3M depicts the total m_{0DESCEND} and propellant mass m_{PROP}_DESCEND in descent with orbital payloads of 1, 8, and 64 Tons to the target altitude of 761 km with s_{f} in the range of 1≤s_{f}≤2, where s_{f}=rₕ/a_{ORBIT}.

FIG. 3N depicts the rocketry key parameters μ_{A}=(m_{PROP}/m_{O}), for ascend and

μ_{D}=(m_{PROP}/m_{O}) for descend at 255, 781, and 35,786 km launch altitudes.

In a very short summary, the method of launching a given orbital payload to an orbit defined by an elliptical orbit having semi-major axis a is as follows:

Calculate rₕ₁, the optimal distance from the center of the earth which maximizes the propellant saving compared to the most efficient prior art launching methods to launch the same orbital payload to the desired targeted desired orbit, such as employing gravity turn as shown in FIG. 3I and formulated by (3.17).

To be able to calculate this curve as a function of s_{f} in the analytically proven range of

1≤s_{f}≤2, where s_{f}=rₕ/a_{ORBIT}, we first need to calculate the propellant mass m_{0PROP} for launching the given orbital payload to the targeted elliptical orbit using the most efficient launch trajectory available. This task is done by using “Rocket Designer” and gives the mass m_{0PROP} which appears in the denominator of (3.17).

This step involves solving equation of motion in three dimensions in an inverse square gravitational field for a “targeted” launch parameters.

Using “Orbit Designer” calculate propellant mass m₀ (s_{f}) which is as indicated being a function of s_{f}, using large enough sampling points n giving a smooth discrete representation of the function (3.17) curve as shown in FIG. 3I.

This step involves solving equation of motion in three dimensions in an inverse square gravitational field, thousands of times employing both descend strategies explained.

Find the maximum s_{f} value which maximizes the % of propellant saving compared to the best prior-art launch trajectory possible given by m_{0PROP}.

FIG. 3O is a flowchart illustrating a method of launch trajectories for one of a plurality of potential orbital configurations. The method is supported by the explanations above and the drawings described herein. In some aspects, some the methods steps may be performed out of the depicted order, or performed simultaneously with other steps. The method begins at Step 300.

Step 302 launches a satellite to a target height (rₕ₁), as high as a first height (rₕ), defined with respect to the center of the Earth. One advantage to this method is that the velocity needed to acquire the target altitude is not limited to a specific range of values. Unlike conventional launch methods that typically require hypersonic speeds to acquire a stable orbit, the rocket in the method described herein can be launched at the lowest velocity needed to acquire the initial (e.g., target) height, which reduces wear-and-tear and minimizes failed launches.

In conventional launch methods, such as employing gravity turn and pitch over maneuvers, the satellite is injected into the desired orbit at the injection point approaching from a lower altitude, against the gravitational attraction force of the Earth. The final stage gives the satellite the velocity vector equal to the final orbital velocity vector (tangential to the orbit at the injection point) which is in the range of (22.8 Mach-7.21 Mach) for orbital altitude ranges of (255 km-60,000 km). These phenomenal highly hypersonic velocities are provided by rocket propulsion at the expense of very high burn rates, which stresses the entire propulsion system. In the method given in [1] and here, the descent stage which carries the satellite into orbit is launched to a calculated higher altitude with no time limit. The only requirement is to reach the calculated distance away from the center of the Earth which satisfies the optimal propellant distance as shown in FIG. 3I for different orbital parameters. The ascent acceleration can be any value larger than 1 g, resulting in much smaller burn rates compared to previous methods to inject the satellite into orbit. Since the descent stage rocket propulsion is in the direction of the gravitational pull, not against it as in prior-art launch methods, gravity assists the rocket in gaining the orbital velocity. This creates far less stress levels on the propulsion system and it becomes very important in increasing the reliability and re-usability of the rocket, which became the main concern in the competitive orbital satellite launch market.

In circular orbits, as given in [1], the magnitude of the orbital velocity is constant at any selected orbital injection point at the descent, only the direction of the velocity vector becomes orbital injection point dependent. How the descent stage approaches the stable orbit also affects the minimum propellant needed. In this work, where the generalized method is given which covers the elliptical orbits, the velocity magnitude and its direction is a function of selected orbital injection point. The issue of how the descent stage approaches the stable orbit also affects the minimum propellant needed.

In Step 304 a gravitational first potential energy is obtained at the target height. In Step 306 the satellite height decreases in response to the gravitational pull of the Earth. In Step 308 the satellite attains a stable orbit around the Earth defined by the formula:

$$\frac{{x}_{1}^{2}}{{a}^{2}} + \frac{{y}_{1}^{2}}{{b}^{2}} = 1 ;$$

where a is a semi-major axis along the x₁ axis passing through the Earth, and where b is a semi-minor axis along the y₁ axis, orthogonal to the x₁ axis, see FIG. 2. When in the stable orbit the satellite has a total energy that is the sum of the satellite gravitational second potential energy and the satellite second kinetic energy, with the satellite total energy being equal to the gravitational first potential energy of Step 304.

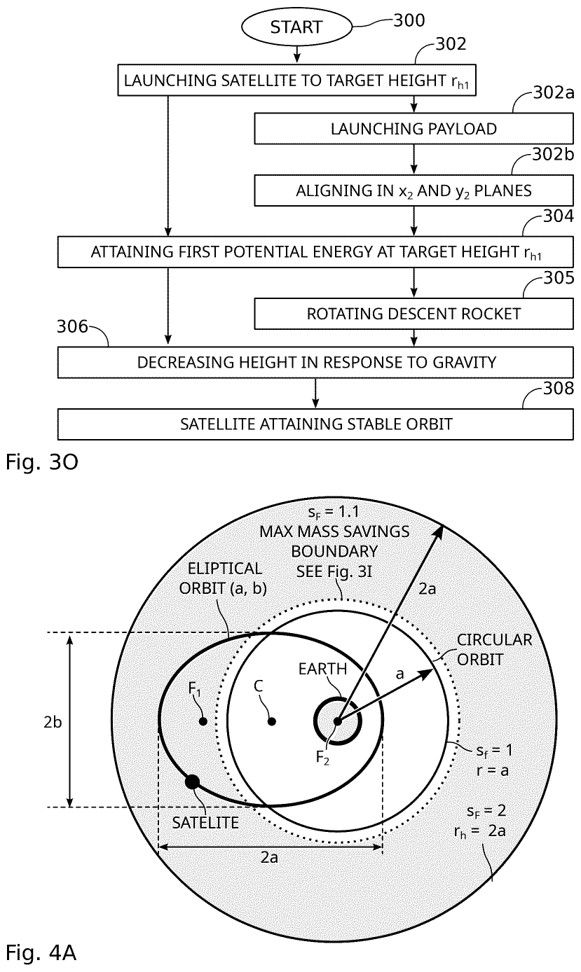

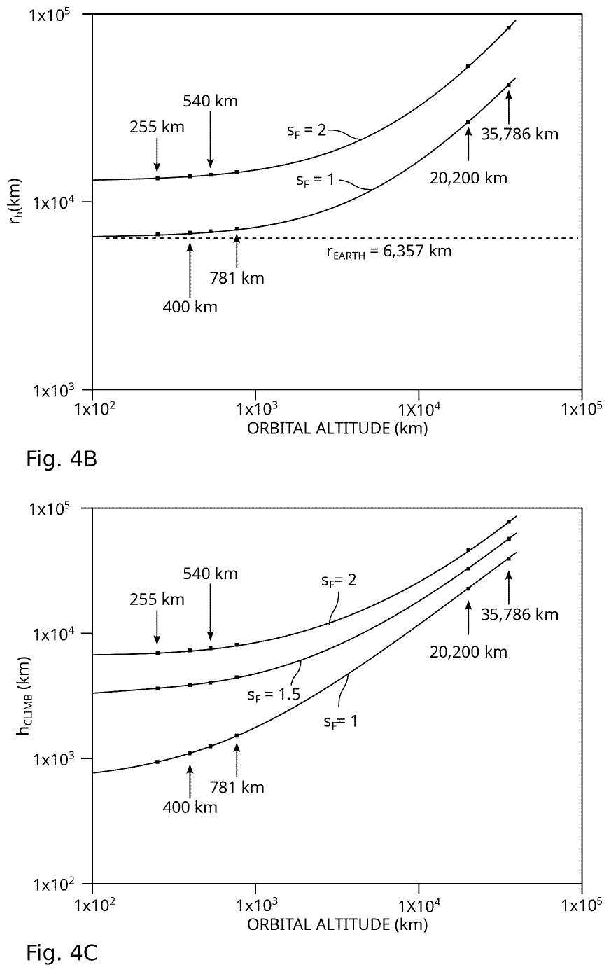

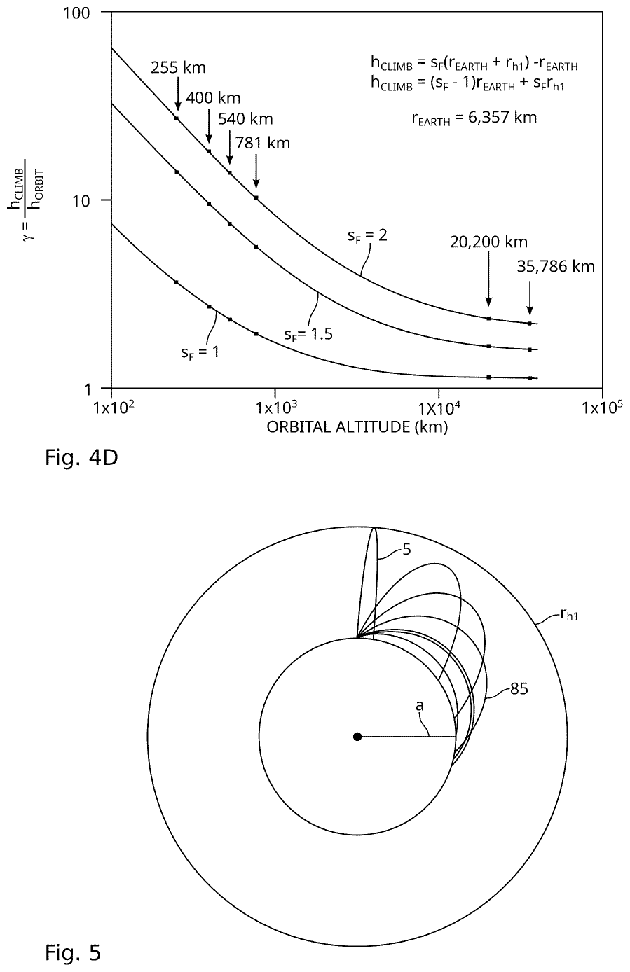

FIG. 4A is a diagram depicting exemplary orbital relationships. In the case where a=b, the stable orbit is circular around point F₂. In the case where a>b, the stable orbit is elliptical and the Earth is located at focal point F₂.

FIG. 4B is a diagram depicting the relationship between rₕ and orbital altitude of 255 km, 400 km, 540 km, 781 km, 20,200 km, and 35,786 km.

FIG. 4C is a diagram depicting the relationship between climb altitude and orbital altitudes of 255 km, 400 km, 540 km, 781 km, 20,200 km, and 35,786 km. FIGS. 4B and 4C provide support for the non-intuitive position that the larger travel distances of the method disclosed herein, as compared to ultimate orbital altitudes or conventional gravity turn maneuver, result in a significant fuel savings when putting the same orbital mass into the same orbital altitude.

FIG. 4D is a diagram depicting the relationship between

$$η = \frac{{h}_{CLIMB}}{{h}_{ORBIT}}$$

and orbital altitudes of 255 km, 400 km, 540 km, 781 km, 20,200 km, and 35,786 km.

As noted above, the total energy (TE) of the satellite in the stable elliptical orbit is equal to its second kinetic energy (KE) plus its second potential energy (PE), and may be expressed by the formula:

$$TE = KE + PE = \frac{1}{2} m {v}^{2} - G \frac{m M}{r} ;$$

Where m is the mass of the satellite, M is the mass of the Earth, G is the universal gravitational constant, v is the velocity of the satellite, and r is the orbital position of the satellite from the center of the Earth. In the case of a circle r is a constant value. In the case of an ellipse, the value of r varies. Thus, while the velocity of a satellite in a stable circular orbit is constant, the satellite velocity in the elliptical stable orbit varies and is defined by the formula:

$$v ( r ) = \sqrt{G M ( \frac{2}{r} - \frac{1}{a} )} .$$

As a result, the satellite TE in the stable elliptical orbit can be redefined by the formulas:

$$\begin{matrix}TE = \frac{1}{2} GmM ( \frac{2}{r} - \frac{1}{a} ) - G \frac{mM}{r} ; \\ = GmM ( \frac{1}{r} - \frac{1}{2 a} - \frac{1}{r} ) ; \\ = - G \frac{Mm}{2 a} .\end{matrix}$$

For both circular and elliptical orbits, if the gravitation first potential energy is attained by the satellite at the first height, then the gravitational first potential energy is equal to the satellite TE in orbit as defined by the formula:

$$- G \frac{m M}{{r}_{h}} = - G \frac{M m}{2 a} .$$

In this particular case it can be seen that the relationship between the first height (rₕ) and the maximum height (perigee) of an elliptical or circular orbit is defined as:

$${r}_{h} = 2 a .$$

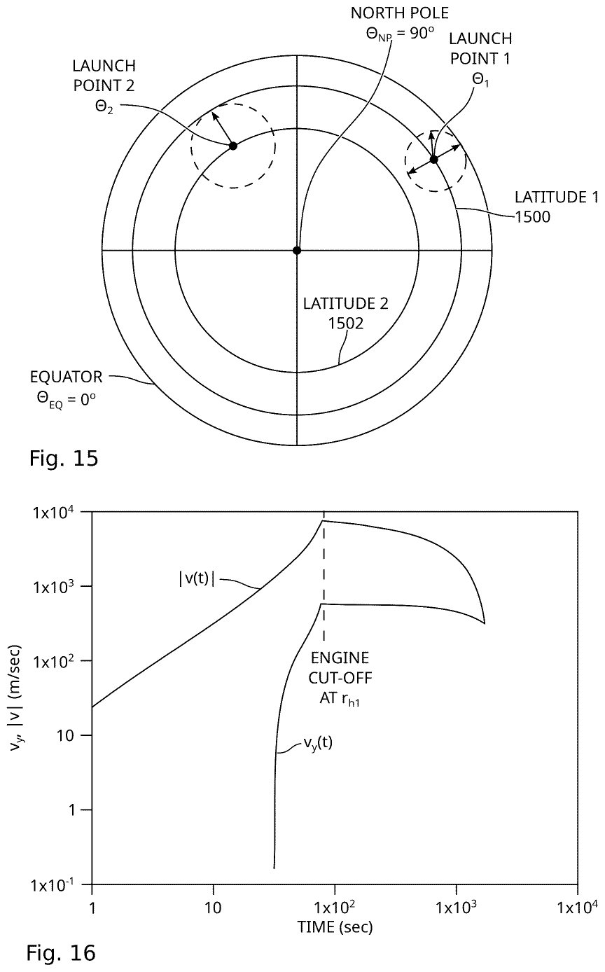

Attaining the stable orbit in Step 308 includes potentially attaining a stable orbit at any orbital inclination angle in the range between 0 and 360 degrees. Further, launching the payload in Step 302 includes potentially launching the satellite from any latitude on a surface of the Earth in the range between 90 and −90 degrees. See FIG. 15.

The above steps describe an ideal case where the satellite, once positioned at the first height, is able to descend to the stable orbit without additional components and without the need for kinetic energy or change in mass. Practically however, the satellite is launched as part of a payload with a descent rocket (and propellant) that is used to tangentially align the satellite with the desired orbit. Thus, Step 302 may include Substep 302a of launching the payload to the target height, and Substep 302b of the descent rocket attaining an alignment in the (x₂, y₂) plane. Then, the method includes the additional Step 305 of rotating the descent rocket into the (x₁, y₁) plane, so that Step 308 describes a stable orbit at any orbital inclination angle in the range between 0 and 360 degrees, see FIG. 18B.

Since the descent rocket and propellant adds additional mass to the mass of the satellite, to obtain the same gravitational first potential energy of only the satellite at the first height, the payload target height need not be as high as the first height. That is, the target height is less than the first height. Thus, launching the payload in Step 302a can be represented with the following formula:

$${r}_{h 1} = {s}_{f} \cdot a where 1.1 < {s}_{f} < 2.$$

As shown in FIG. 3I, the most efficient value of s_{f} for relatively low orbital altitudes (e.g., 400 km to 781 km is in the range of 1.1 to 1.25, and 1.4 to 1.6 for higher latitudes (e.g., 20,200 km to 35,786 km). Conventionally, a large majority of satellites are launched to a LEO orbital altitude of 550 km. Then, Step 304 attains the gravitational first potential energy in response to the combined mass (m_{O}), which is the mass of the satellite (m), descent rocket m_{DEC}, and a first amount of propellant (m_{PROP}), as well as the height defined by s_{f}. The combined mass m_{ORBIT} is often referred to herein as the mass of payload. Since the descent rocket at least initially goes into orbit with the satellite, the mass of the descent rocket is included in both the terms m_{ORBIT} and m_{O}. However, it is simpler to exclude the mass of the descent rocket in both m_{ORBIT} and m_{O}, so that the difference in mass between m_{ORBIT} and m_{O} is simply expressed as m_{PROP}. Alternatively stated, knowing the combined mass of the propellant and satellite, the payload can be launched to a target height where the payload mass has the gravitational first potential energy.

In one aspect, launching the payload in Step 302a includes ascending the payload at a non-vertical angle with respect to the surface of the Earth. Then, the payload attaining the gravitational first potential energy in Step 304 includes the payload having a third kinetic at the target height, where the first potential energy is greater than the third kinetic energy, see FIG. 16. Decreasing the satellite height in response to a gravitational pull of the Earth in Step 306 includes, subsequent to rotating the descent rocket, the descent rocket applying a velocity adjustment thrust and creating a first angle of descent tangential to the stable orbit. Then Step 308 includes the satellite ultimately separating from the descent rocket subsequent to the velocity adjustment thrust (the burning of the first amount of descent rocket propellant necessary to obtain orbit). In other words, a reduction in potential energy due to a lower initial launch height can be offset by a greater payload mass.

The difference in mass between altitude rₕ₁ (m₀) and the mass at the orbit having semi-major axes a (m_{ORBIT}) as defined in equation (2.17) is equal to the consumed propellant m_{PROP} in the descent.

$$\frac{1}{2} {{m}_{ORBIT} [ {v}_{e} ln ( \frac{{m}_{0}}{{m}_{ORBIT}} ) ]}^{2} - G \frac{M {m}_{0}}{{r}_{h 1}} = - G \frac{M {m}_{ORBIT}}{2 a}$$

The left side of the relation (2.17) is the total energy (kinetic+potential) at rₕ. Burning the entire m_{PROP} beginning at the altitude rₕ₁ is given by the impulsive solution of the Tsiolkovsky Rocket Equation. The right-hand side of the equation is the total energy (kinetic+potential) in the stable elliptical orbit with semi-major axes a.

Solving (2.17) for rₕ as given in (2.23) gives,

$${r}_{h 1} = \frac{1}{{\frac{1}{2 GM} [ {v}_{e} ln ( 1 + \frac{{m}_{P R O P}}{{m}_{ORBIT}} ) ]}^{2} + \frac{1}{2 a}}$$

Where vₑ is exhaust gas velocity relative to the descent rocket, giving rₕ₁=rₕ=2a for m_{PROP}=0 and rₕ₁≤2a for m_{PROP}≥0 as given in (2.23) and shown in FIG. 21.

The target height can optimally be a value that minimizes the velocity adjustment thrust required to create the first angle tangent to the stable orbit. Likewise, the payload non-vertical ascension angle can optimally be selected to minimize the velocity adjustment thrust required to create the first angle tangent to the stable orbit.

As noted above, in the case of an elliptical orbit where a>b, the satellite velocity in the elliptical stable orbit defined by the formula:

$$v ( r ) = \sqrt{GM ( \frac{2}{r} - \frac{1}{a} )} .$$

In this case r is a variable, as the distance of the satellite from the center of the Earth changes as the path traced through the ellipse, defined by the semi-major axis a, changes. As a result of the change in the value r, the orbital velocity of the satellite changes. As noted above, the velocity at which the satellite is inserted into an elliptical orbit depends upon the elliptical orbit insertion point.

In this rocket assisted descent maneuver the payload applies no force to counter the force of gravity, but rather, relies upon the force of gravity as well as a minimal amount of thrust to modify the angle of descent to send the payload into a stable lower altitude orbit. The rocket assisted descent maneuver can be assisted by gimbaling the rocket engines, or using auxiliary directional thrusters.

FIG. 5 is a diagram depicting launch angles of 5, 30, 45, 60, 75, and 85 degrees from vertical with corresponding variances in launch heights to obtain a circular orbit with a radius of a. A payload launched to the target height at the angle of 5 degrees is an efficient use of energy. As noted above, an orbit can be attained with values of less than 2 s_{f} and at angles of greater than 5 degrees for example, but in this case the descent rocket may be required to supply greater thrust to obtain an angle tangential to the desired orbit if the overall mass of the payload is insufficient to create the first potential energy at the target height. Likewise, large ascension angles are more likely to require more descent rocket thrust to obtain orbital insertion.

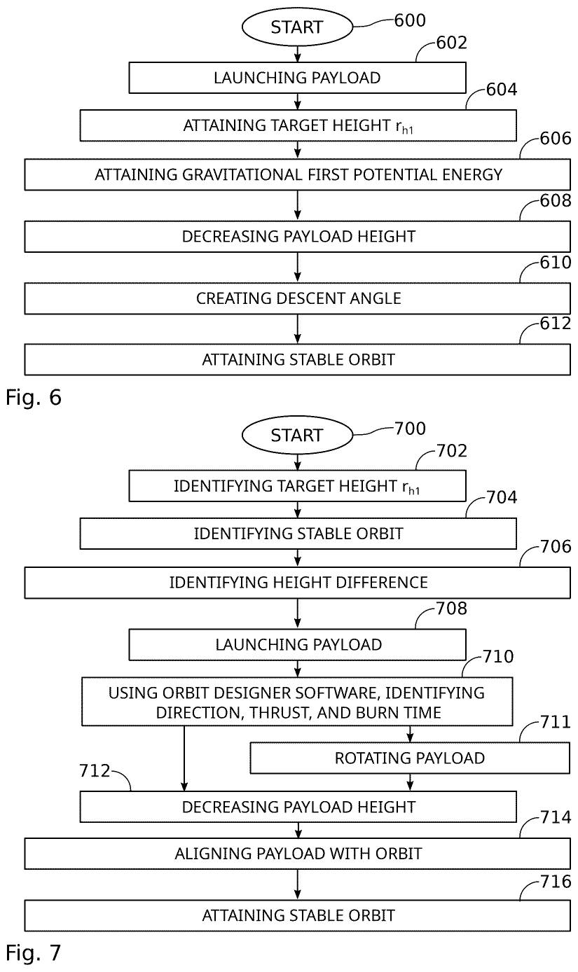

FIG. 6 is a flowchart illustrating another aspect of launch trajectories for one of a plurality of potential orbital configurations. The method begins at Step 600. At Step 602 a payload, including a satellite, descent rocket, and a first amount of descent rocket propellant, is launched from the surface of the Earth. In Step 604 the payload attains a non-orbiting target height (rₕ₁), defined with respect to the center of the Earth, and in Step 606 the payload attains a gravitational first potential energy and a first kinetic energy at the target height, where the first gravitational energy is greater than the first kinetic energy. In Step 608 the payload height is decreased in response to the gravitational pull of the Earth. Step 610 creates a first angle of descent (inclination angle) tangential to a stable orbit around the Earth, responsive to a velocity adjustment thrust. In Step 612 the satellite attains the stable orbit, after burning the first amount of propellant, defined by the formula:

$$\frac{{x}_{1}^{2}}{{a}^{2}} + \frac{{y}_{1}^{2}}{{b}^{2}} = 1 ;$$

where a is a semi-major axis along the x₁ axis passing through the Earth, and where b is a semi-minor axis along the y₁ axis, orthogonal to the x₁ axis. Attaining the target height in Step 604 includes creating a relationship between the target height and the stable orbit semi-major axis length height expressed as:

$${r}_{h 1} = {s}_{f} \cdot a where 1.1 < {s}_{f} < 2 .$$

As presented above,

$$\frac{1}{2} {{m}_{ORBIT} [ {v}_{e} ln ( \frac{{m}_{0}}{{m}_{ORBIT}} ) ]}^{2} - G \frac{M {m}_{0}}{{r}_{h 1}} = - G \frac{M {m}_{ORBIT}}{2 a}$$

Solving (2.17) for rₕ₁ as given in (2.23) gives,

$${r}_{h 1} = \frac{1}{{\frac{1}{2 GM} [ {v}_{e} ln ( 1 + \frac{{m}_{P R O P}}{{m}_{ORBIT}} ) ]}^{2} + \frac{1}{2 a}}$$

Where vₑ is exhaust gas velocity relative to the descent rocket, giving rₕ₁=rₕ=2a for m_{PROP}=0 and rₕ₁≤2a for m_{PROP}≥0 as given in (2.23) and shown in FIG. 21

In another aspect, attaining the target height in Step 604 includes initially aligning the descent rocket in a (x₂, y₂) plane as a result of the ascension angle, and creating the first angle of descent in Step 610 responsive to velocity adjustment thrust includes rotating the payload at the target height prior to descent in the (x₁, y₁) plane. As a result, Step 612 describes a stable orbit at any orbital inclination angle in the range between 0 and 360 degrees.

FIG. 7 is a flowchart illustrating another variation of a method of launch trajectories for a number of potential orbital configurations. The method begins at Step 700. For a payload including a descent rocket, a first amount of descent rocket propellant, and a satellite, Step 702 identifies a target height (rₕ₁) with respect to the center of the Earth. Step 704 identifies a stable orbit around the Earth defined by the formula:

$$\frac{{x}_{1}^{2}}{{a}^{2}} + \frac{{y}_{1}^{2}}{{b}^{2}} = 1 ;$$

where a is a semi-major axis along the x₁ axis passing through the Earth, and where b is a semi-minor axis along the y₁ axis, orthogonal to the x₁ axis. Step 706 identifies a height difference between the target height and a. Step 708 launches the payload to the target height from a surface of the Earth. Using an Orbit Designer software program, Step 710 identifies a direction α_{F}, thrust F_{D}, and descent burn time T_{BD} from the target height. As would be conventional, the Orbit Designer software can be enabled as a sequence of processor executable instructions performed by a computer. In Step 712 the payload height is decreased in response to the pull of gravity. Step 714 tangentially aligns the payload with the stable orbit in response to the height difference, direction α_{F}, thrust F_{D}, and descent burn time T_{BD}. In Step 716, subsequent to burning the first amount of propellant, the satellite obtains the stable orbital.

The target height is expressed with a scaling factor S_{f}, where:

$${r}_{h 1} = {s}_{f} \cdot a where 1.1 < {s}_{f} < 2$$

As presented above,

$$\frac{1}{2} {{m}_{ORBIT} [ {v}_{e} ln ( \frac{{m}_{0}}{{m}_{ORBIT}} ) ]}^{2} - G \frac{M {m}_{0}}{{r}_{h 1}} = - G \frac{M {m}_{ORBIT}}{2 a}$$

Solving (2.17) for rₕ₁ as given in (2.23) gives,

$${r}_{h 1} = \frac{1}{{\frac{1}{2 GM} [ {v}_{e} ln ( 1 + \frac{{m}_{P R O P}}{{m}_{ORBIT}} ) ]}^{2} + \frac{1}{2 a}}$$

Where vₑ is exhaust gas velocity relative to the descent rocket, giving rₕ₁=rₕ=2a for m_{PROP}=0 and rₕ₁≤2a for m_{PROP}≥0 as given in (2.23) and shown in FIG. 21

In one aspect, launching the payload to the target height in Step 708 includes initially aligning the descent rocket in a (x₂, y₂) plane, and Step 711 rotates the payload at the target height to align in the (x₁, y₁) plane, so that Step 716 describes a stable orbit at any orbital inclination angle in the range between 0 and 360 degrees. Step 711 may be performed before, after, or during Step 712.

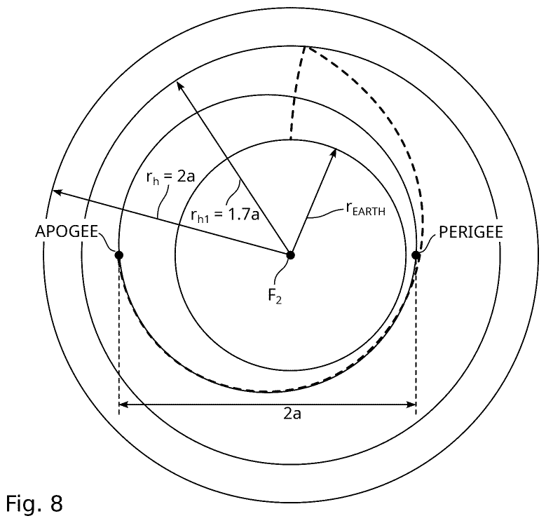

FIG. 8 is a diagram depicting an elliptical orbital plane plot with a perigee of 400 kilometers (km) where rₕ₁=1.7a (1.7a_{ORBIT}), which is sf=1.7. As noted above, the payload descent rocket stage applies thrust responsive the angle of launch and mass of the payload, in addition to the value of sf.

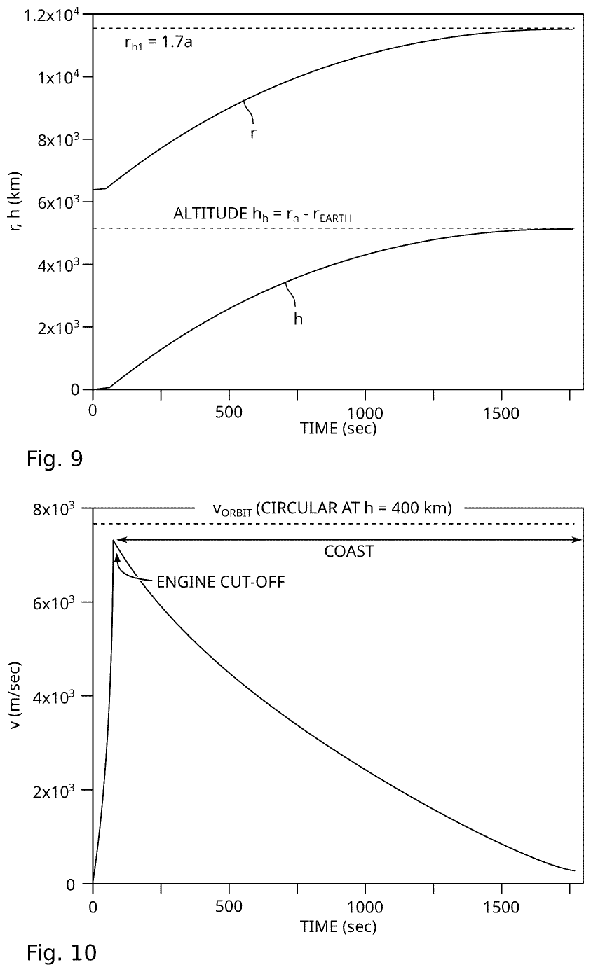

FIG. 9 is a diagram of the ascent time r(t) for an elliptical orbit with a perigee of 400 km from the center of the Earth, where rₕ₁=1.7a (sf=1.7). For comparison the height h(t) from the surface of the Earth (altitude) is also shown.

FIG. 10 is a diagram of the ascent velocity for an elliptical orbit with a perigee of 400 km, where rₕ₁=1.7a (s_{f}=1.7).

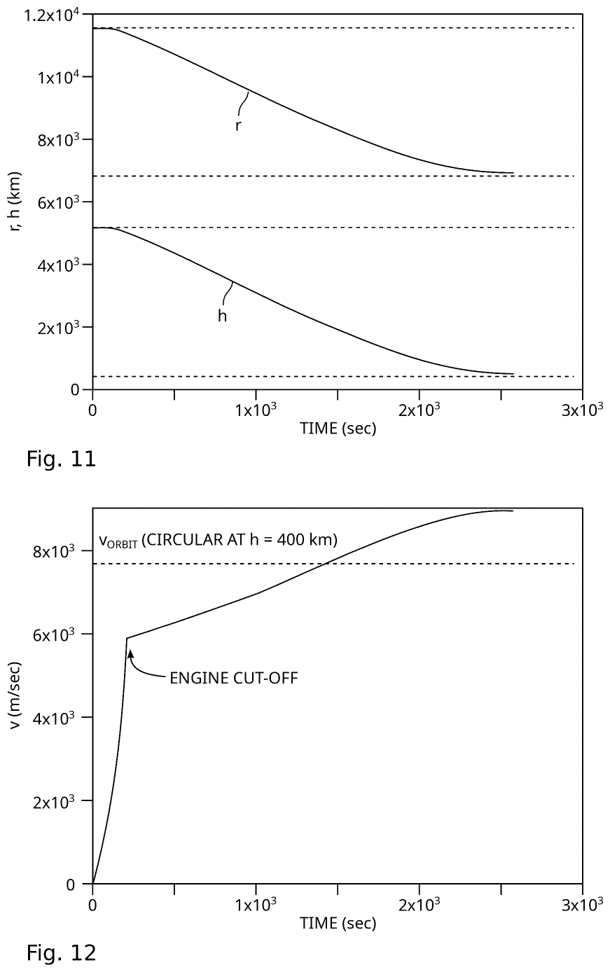

FIG. 11 is a diagram depicting r(t) and h(t) descent for an elliptical orbit, where rₕ₁=1.7a (sf=1.7).

FIG. 12 is a diagram depicting the descent velocity profile for an elliptical orbit, where rₕ₁=1.7a (sf=1.7). For comparison the velocity (v_{ORBIT}) for a circular orbit at a perigee of 400 km is also shown.

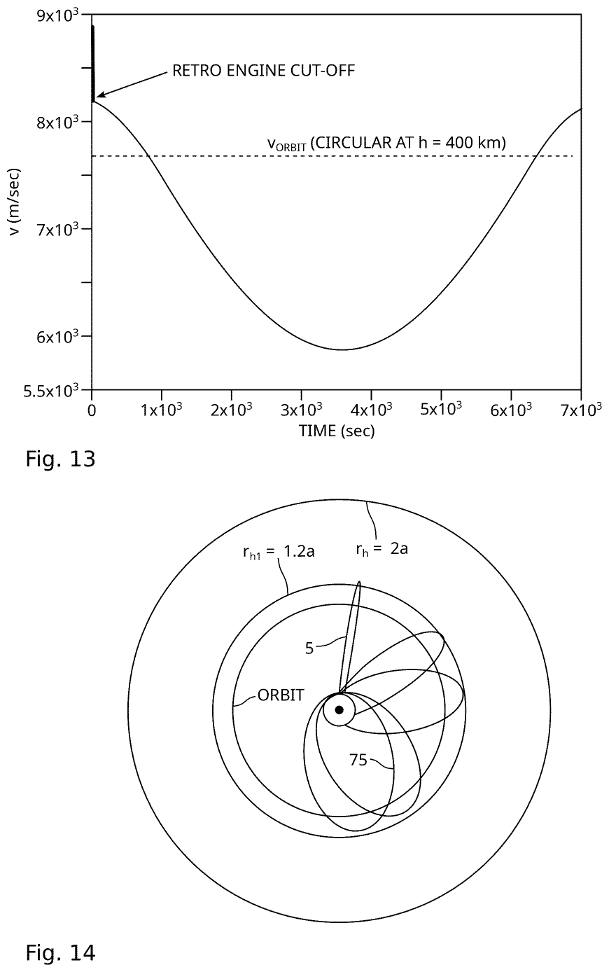

FIG. 13 is a diagram depicting the orbital injection velocity required for an elliptical orbit, where rₕ₁=1.7a (sf=1.7). For comparison the velocity (v_{ORBIT}) for a circular orbit with a perigee of 400 km is also shown.

FIG. 14 is a diagram depicting ballistic trajectories for the launch angles of 5, 30, 45, 60, and 70 degrees, where rₕ₁=1.2a (sf=1.2) and the slightly elliptical orbit with a perigee of 35,786 km. Assuming the payload mass is a constant, the thrust required by the descent rocket changes with changes in angle.

FIG. 15 is a plan view of launch examples with the Earth centered on the polar axis. Returning to FIG. 3O, attaining the stable orbit in Step 308 includes potentially attaining a stable orbit at any orbital inclination angle in the range between 0 and 360 degrees. Exemplary inclination angles of θ₁ and θ₂ are shown in the figure. Further, launching the payload in Step 302 includes potentially launching the payload from any latitude on a surface of the Earth in the range between 90 and −90 degrees. Launch point 1 at latitude 1 1500 and launch point 2 at latitude 2 1502 are shown.

FIG. 16 is a diagram depicting the energy associated with launching a payload at an angle of 5 degrees. After a vertical lift-off, the ascent rocket and payload assume the 5 degree angle. As can be seen the velocity associated with the launch “peters” out after the engines are cut off. This post-engine cut-off velocity increases as the launch angle increases.

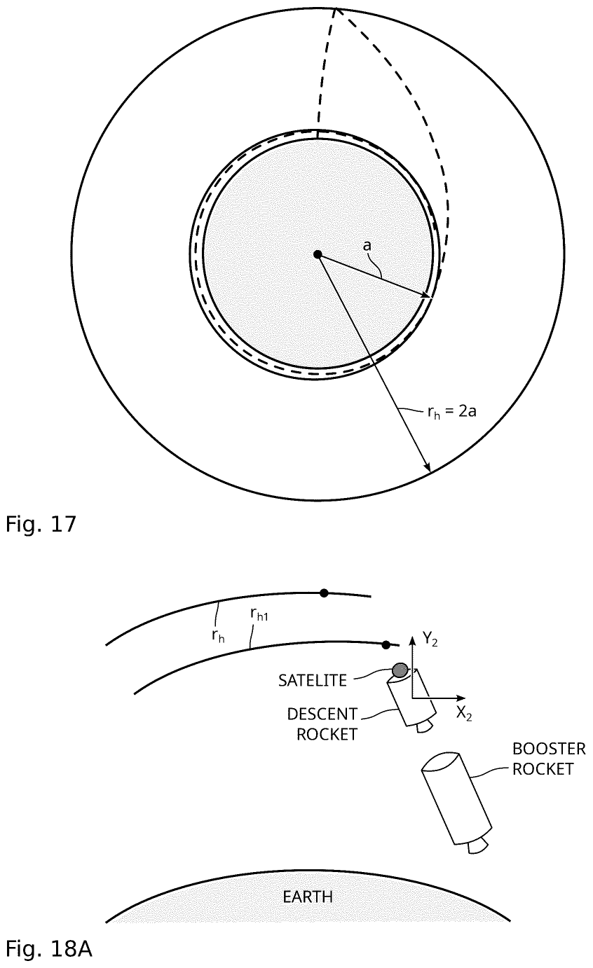

FIG. 17 is a diagram depicting an orbital plane plot for a circular orbit with a perigee of 400 km, with r=a and rₕ=2a.

FIG. 18Aa is a cross-sectional diagram depicting a payload reaching the target height rₕ₁ and attaining alignment in that position in x₂ and y₂ planes.

FIG. 18B is a plan view of FIG. 18A depicting the rotation of the payload from the (x₂, y₂) plane to the (x₁, y₁) plane associated with the orbit that the satellite will ultimately attain. It should be noted that the descent rocket can be rotated to any inclination angle in the range of 0 to 360 degrees, such that no conventional plane change maneuvers are required.

FIG. 18C is a cross-sectional view depicting the payload initially descending, due to gravitational potential, in the desired inclination angle, which is in the (x₁, y₁) plane, followed by the velocity adjustment thrust required to align the satellite with its desired orbit. The descent rocket applies thrust to align the payload tangent to the desired orbit for insertion.

Methods have been provided for the efficient launch of orbital satellites and spacecraft. Examples of particular method steps and hardware units have been presented to illustrate the invention. However, the invention is not limited to merely these examples. Other variations and embodiments of the invention will occur to those skilled in the art.

### REFERENCES

“Efficient Method for Orbital Launch Trajectories”, O. E. Akcasu, U.S. Pat. No. 12,172,774 B1.
Walter Lewin, MIT Physics Lectures
“Orbital Mechanics for Engineering Students”, Fourth Edition, Howard D. Curtis, Copyright 2021, Elsevier
ISBN:978-0-12-824025-0
4. “Space Flight Dynamics”, Craig A. Kluever, Copy Right 2018, John Wiley and Sons, ISBN 978-1-119-15782-3
5. “Fundamentals of Celestial Mechanics”, J M A Danby, Willmann-Bell, Inc. Copyright 1962, 1988, 1992 by John M. A. Danby, ISBN 0-943396-20-4
6. “Spacecraft Guidance”, Space System Design, MAE 342, Princeton University
Robert Stengel Copyright 2016 by Robert Stengel. All rights reserved. For educational use only.
http://www.princeton.edu/-stengel/MAE342.html
7. Dr. Giordano Scarciotti, Imperial Collage, Convex Optimization,
Youtube.com/watch?v=Kk5J, “How does SpaceX Optimize Rocket Launches”.
8. “Modern Compressible Flow”, Fourth Edition, John D. Anderson, Jr., Copyright 2021, McGraw Hill, ISBN 978-1-260-57082-3.
9. “Hypersonic and High Temperature Gas Dynamics”, Third Edition, John D. Anderson Jr, Copyright 2019 American Institute of Aeronautics and Astronautics Inc.,
ISBN 978-1-62410-514-2.
10. Tech Ingredients https://www.youtube.com/watch?v=nPM3KcHzN6I.

### References from U.S. Pat. No. 12,172,774 B1

### References on Rocket Equation and Space

11. “Lecture L14—Variable Mass Systems: The Rocket Engine”, J. Peraire, S. Widnal, 11.07 Dynamics, Fall 2008, Version 2.0.
12. “Lecture 14.2. The Rocket Equation”, https://web.mit.edu/16.unified/www/SPRING/propulsion/notes/node103.html “Tsiolkovsky Rocket Equation”,
13. https://en.wikipedia.org/wiki/Tsiolkovysky_rocket_equation.
14. “Free Fall”, https://en.wikipedia.org/wiki/Free_fall
15. “From Moon-Fall to Motions Under Inverse Square Laws”, S. K. Foong, European Journal of Physics, 2008, Vol 29, Number 5, pp. 987-1003.
16. Everydayastraunat.com, Tim Dodd
17. “Rocket Factory”, Smarter everyday you tube program by, Destin Sandlin with Tory Bruno, CEO of ULA (United Launch Alliance),
https://www.youtube.com/watch?v=DQaPOIQLEUo
18. “Launch Azimuth, Orbital Inclination, Launch Site Latitude Rocket Trajectories 6”, Alfanso Gonzales, https://www.youtube.com/watch?v=UIXiK41yl_w
19. Lecture 14: “Orbits and Escape Velocity” 8.01 Classical Mechanics, Fall 1999, Walter Lewin https://www.youtube.com/watch?v=CW353dqcbtA
20. “Gravity Turn”, https:/en.wikipedia.org/wiki/Gravity_turn
21. ULA's Transformation and Vision for the Future of Space Launch”, Tory Bruno, CEO of ULA,
https://www.youtube.com/watch?v=6fpvvd6K6LY

### References on Guidance and Equation of Motion

22., “Solar Timer Using GPS Technology”, O. E. Akcasu and Ibrahim Akcay, U.S. Pat. No. 9,551,980 B2, Jan. 24, 2017.
23. “Method and Apparatus for Controlling Electrical Power Usage Based on exact Sun Elevation Angle and Measured Geographical Location”, Osman E. Akcasu, USPTO 9,949,339 B2, Apr. 17, 2018.
24. “Vehicle for Aerial Delivery of Fire Retardant”, O. E. Akcasu, U.S. Pat. No. 7,975,774 B2, Jul. 12, 2011.
25. “System for Aerial Delivery of Fire Retardant”, O. E. Akcasu, U.S. Pat. No. 8,165,731 B2, Apr. 24, 2012.
26. “System for Aerial Delivery of Fire Retardant”, O. E. Akcasu, European Union Patent Number EP 2,163,279, Feb. 25, 2013.
27. “Vehicle for Aerial Delivery of Fire Retardant”, O. E. Akcasu, European Union Patent Number EP 2,163,844 B1, Aug. 12, 2015.
28. “Rocket or Artillery Launched Smart Reconnaissance Pod”, O. E. Akcasu, Ibrahim Onur Uslu and Yusuf Leblebici, U.S. Pat. No. 9,234,728 B2, Jan. 12, 2016.
29. “Rocket or Artillery Launched Smart Reconnaissance Pod”, O. E. Akcasu, Ibrahim Onur Uslu and Yusuf Leblebici, European Patent EP 2 871 438 B1, 11 Apr. 2018.
30. “JPL and the Space Age: Hunt for Space Rocks”, https://www.youtube.com/watch?v=1wNzTyu36WA

### References on Math and Physics in General

31. “Gravitational Potential Energy”, https:/en.wikipedia.org/wiki/Gravitational_energy
32. “Capacitor with High Aspect Ratio Silicon Cores”, O. E. Akcasu, U.S. Pat. No. 10,510,828 B2, Dec. 17, 2019.
33. “The Feynman Lectures on Physics”, Richard P. Feynman, Robert B. Leighton, Matthew L. and Sands, Copyright 1963, 1989 California Institute of Technology, ISBN 0-201-51003-0, Vol. II, pp. 7.9.
34. “Mathematical Handbook of Formulas and Tables,” Murray R. Spiegel, Schaum's Outline Series, Copyright 1952 by McGraw-Hill, Inc.
35. “Handbook of Mathematical Functions,” Edited by Milton Abramowitz and Irene A. Stegun, Dover Publications, Inc., New York, 1972, Library of Congress Catalog Card Number: 65-12253.
36. “Handbook of Chemistry and Physics,” 66^{th} Edition, 1985-1986, Copyright CRC Chemical Rubber Publishing Company, ISBN-0-8493-0466-0.
37. “Applied Numerical Analysis,” C. F. Gerald, Addison-Wesley Publishing Co., 1980, ISBN 0-201-02696-1.
38. “Functional Analysis and Applied Mathematics”, L. V. Kantorovich, Usepkhi Mat. Nauk., Vol. 3, pp. 89-185, 1948.
39. “Discrete Variable Methods in Ordinary Differential Equations”, P. Henrici, Wiley, New York, 1962.
40. “Convergence Properties of Newton's Method for the Solution of Semiconductor Carrier Transport Equations and Hybrid Solution Techniques for Multidimensional Simulation of VLSI Devices”, O. E. Akcasu, Solid-State Electron. Vol. 27, pp. 319-328, April 1984.
41. “Brachistochrone Curve”, https:/en.wikipedia.org/wiki/Brachistochrone_curve
42. “Brachistochrone Curve” https://www.youtube.com/watch?v=3HXCv4dmR7A
43. “Brachistochrone Curve” https://www.youtube.com/watch?v=zYOAUG8PxyM&t=2s

1. A system for launch trajectories into one of a plurality of potential orbital configurations, the system comprising:
a booster rocket, a satellite, and an Orbit Designer software program controller:
the controller providing a calculation of a launch of the satellite to a target height (rₕ₁), as high as a first height (rₕ), defined with respect to the center of the Earth;
the controller providing a calculation of a gravitational first potential energy at the target height;
the controller providing a calculation of a decrease in the satellite height in response to a gravitational pull of the Earth;
the controller providing a calculation of the satellite attaining a stable orbit around the Earth defined by the formula:
$$\frac{{x}_{1}^{2}}{{a}^{2}} + \frac{{y}_{1}^{2}}{{b}^{2}} = 1 ;$$
where a is a semi-major axis along a x₁ axis passing through the Earth; and,
where b is a semi-minor axis along a y₁ axis, orthogonal to the x₁ axis.

2. The system of claim 1 wherein launching the satellite includes launching the satellite from any latitude on a surface of the Earth in the range between 90 and −90 degrees.

3. The system of claim 1 wherein the satellite attaining the stable orbit includes the satellite having a total energy in orbit that is the sum of a gravitational second potential energy and a second kinetic energy, with the satellite total energy being equal to the gravitational first potential energy.

4. The system of claim 1 where a is greater than or equal to b.

5. The system of claim 3 wherein the total energy (TE) of the satellite in the stable orbit is equal to its second kinetic energy (KE) plus its second potential energy (PE) defined by the formula:
$$TE = KE + PE = \frac{1}{2} {mv}^{2} - G \frac{mM}{r} ;$$
where m is the mass of the satellite;
where M is the mass of the Earth;
where G is the universal gravitational constant;
where V is the velocity of the satellite; and,
where r is the orbital position of the satellite from the center of the Earth.

6. The system of claim 5 wherein a>b and the satellite velocity in the elliptical stable orbit defined by the formula:
$$v ( r ) = \sqrt{GM ( \frac{2}{r} - \frac{1}{a} )} .$$

7. The system of claim 6 wherein the satellite TE in the stable elliptical orbit is redefined by the formula:
$$\begin{matrix}TE = \frac{1}{2} GmM ( \frac{2}{r} - \frac{1}{a} ) - G \frac{mM}{r} ; \\ = GmM ( \frac{1}{r} - \frac{1}{2 a} - \frac{1}{r} ) ; \\ = - G \frac{Mm}{2 a} .\end{matrix}$$

8. The system of claim 7 wherein the gravitation first potential energy is attained by the satellite at the first height, and the gravitation first potential energy is equal to the satellite TE in orbit as defined by the formula:
$$- G \frac{mM}{{r}_{h}} = - G \frac{Mm}{2 a} .$$

9. The system of claim 8 wherein the relationship between the first height (rₕ) and the maximum height of the stable orbit is defined as:
$${r}_{h} = 2 a .$$

10. The system of claim 1 wherein the satellite attaining the stable orbit includes attaining a stable orbit at any orbital inclination angle in the range between 0 and 360 degrees.

11. The system of claim 1 wherein launching the satellite includes:
launching a payload to the target height, where the payload comprises the satellite, a descent rocket, and a first amount of descent rocket propellant;
the controller calculating the descent rocket attaining alignment in a (x₂, y₂) plane prior to its descent;
the system further comprising:
the controller providing a calculation of the descent rocket rotation to align in the (x₁, y₁) plane; and,
wherein the satellite attaining the stable orbit includes attaining a stable orbit at any orbital inclination angle in the range between 0 and 360 degrees.

12. The system of claim 11 wherein launching the payload to the target height includes defining the target height as follows:
$${r}_{h 1} = {s}_{f} \cdot a where 1.1 < {s}_{f} < 2 ;$$
wherein providing the calculation of the gravitational first potential energy includes the controller providing a calculation of the payload attaining the gravitational first potential energy in response to the combined mass of the satellite, the first amount of propellant, and the descent rocket, as well as the height defined by s_{f}.

13. The system of claim 12 wherein
a<8400 km; and,
s_{f}<1.25.

14. The system of claim 12 wherein launching the payload includes ascending the payload at a non-vertical angle with respect to the surface of the Earth;
wherein providing the calculation of the payload attaining the gravitational first potential energy at the target height includes the payload having a third kinetic energy at the target height, where the gravitational first potential energy is greater than the third kinetic energy;
wherein decreasing the satellite height in response to a gravitational pull of the Earth includes the controller providing a calculation of the descent rocket applying a velocity adjustment thrust and creating a first angle of descent tangential to the stable orbit occurring subsequent to the descent rocket rotation; and,
wherein the satellite attaining the stable orbit includes the satellite separating from the descent rocket subsequent to the burning of the first amount of propellant in velocity adjustment thrust.

15. The system of claim 12 wherein launching the payload to the target height includes the controller providing the calculation of the target height as follows:
$$\frac{1}{2} {{m}_{ORBIT} [ {v}_{e} ln ( \frac{{m}_{0}}{{m}_{ORBIT}} ) ]}^{2} - G \frac{{Mm}_{0}}{{r}_{h 1}} = - G \frac{{Mm}_{ORBIT}}{2 a}$$
$${r}_{h 1} = \frac{1}{{\frac{1}{2 GM} [ {v}_{e} ln ( 1 + \frac{{m}_{PROP}}{{m}_{ORBIT}} ) ]}^{2} + \frac{1}{2 a}}$$
where vₑ is exhaust gas velocity relative to the descent rocket;
where m_{ORBIT} is the mass of the satellite and descent rocket;
where m₀ is the mass of the satellite, the descent rocket, and the mass of the first amount of propellant m_{PROP} at the target height;
where rₕ₁=rₕ=2a for m_{PROP}=0 and,
where rₕ₁≤2a for m_{PROP}≥0.

16. The system of claim 14 wherein the controller providing the calculation of the descent rocket applying the velocity adjustment thrust includes using a method selected from the group consisting of a two-step and three-step burn method.

17. The system of claim 1 wherein launching the satellite includes:
the controller providing a calculation of launching a payload to the target height rₕ₁, where the payload mass m_{O} comprises a mass of the satellite and descent rocket (m_{ORBIT}) and a mass of a first amount of descent rocket propellant (m_{PROP}), and where rₕ₁ is a function of m_{ORBIT} and m_{PROP} as follows;
$${r}_{h 1} = f ( {m}_{RAT} ) < 2 a ; and ,$$
$$where {m}_{RAT} = \frac{{m}_{PROP}}{{m}_{ORBIT}} .$$

18. A method for launch trajectories into one of a plurality of potential orbital configurations, the method comprising:
launching a payload including a descent rocket, a satellite, and a first amount of descent rocket propellant from a surface of the Earth;
the payload attaining a non-orbiting target height (rₕ₁), defined with respect to the center of the Earth;
the payload attaining a gravitational first potential energy and a first kinetic energy at the target height, where the first gravitational energy is greater than the first kinetic energy;
decreasing the payload height in response to the Earth's gravitational pull;
creating a first angle of descent tangential to a stable orbit around the Earth, responsive to a velocity adjustment thrust; and,
after burning the first amount of propellant, the satellite attaining the stable orbit defined by the formula:
$$\frac{{x}_{1}^{2}}{{a}^{2}} + \frac{{y}_{1}^{2}}{{b}^{2}} = 1 ;$$
where a is a semi-major axis along a x₁ axis passing through the Earth; and,
where b is a semi-minor axis along a y₁ axis, orthogonal to the x₁ axis.

19. The method of claim 18 wherein the payload attaining the target height includes creating a relationship between the target height and the stable orbit semi-major axis length expressed as:
$${r}_{h 1} = {s}_{f} \cdot a where 1.1 < {s}_{f} < 2.$$

20. The method of claim 19 wherein the payload attaining the target height WA includes calculating the target height as follows:
$$\frac{1}{2} {{m}_{ORBIT} [ {v}_{e} ln ( \frac{{m}_{0}}{{m}_{ORBIT}} ) ]}^{2} - G \frac{{Mm}_{0}}{{r}_{h 1}} = - G \frac{{Mm}_{ORBIT}}{2 a}$$
$${r}_{h 1} = \frac{1}{{\frac{1}{2 GM} [ {v}_{e} ln ( 1 + \frac{{m}_{PROP}}{{m}_{ORBIT}} ) ]}^{2} + \frac{1}{2 a}}$$
where vₑ is exhaust gas velocity relative to the descent rocket;
where m_{ORBIT} is the mass of the satellite and descent rocket;
where m₀ is the mass of the satellite, the descent rocket, and the mass of the first amount of propellant m_{PROP} at the target height;
where rₕ₁=2a for m_{PROP}=0 and,
where rₕ₁≤2a for m_{PROP}≥0.

21. The method of claim 18 wherein attaining the target height includes initially aligning the descent rocket in a (x₂, y₂) plane; and,
wherein creating the first angle of descent responsive to velocity adjustment thrust includes rotating the payload at the target height, prior to descent, in the (x₁, y₁) plane; and,
wherein attaining the stable orbit includes obtaining a stable orbit at any orbital inclination angle in the range between 0 and 360 degrees.

22. A method of obtaining launch trajectories for one of a plurality of potential orbital configurations, the method comprising:
for a payload including a descent rocket, a satellite, and a first amount of propellant, an Orbit Designer software program identifying a target height (rₕ₁) with respect to the center of the Earth;
the Orbit Designer software program identifying a stable orbit around the Earth defined by the formula:
$$\frac{{x}_{1}^{2}}{{a}^{2}} + \frac{{y}_{1}^{2}}{{b}^{2}} = 1 ;$$
where a is a semi-major axis along a x₁ axis passing through the Earth;
where b is a semi-minor axis along a y₁ axis, orthogonal to the x₁ axis;
the Orbit Designer software program identifying a height difference between the target height and a;
the Orbit Designer software program, identifying a direction α_{F}, thrust F_{D}, and descent burn time T_{BD} from the target height;
the Orbit Designer software program identifying a decrease in the payload height in response to the pull of gravity;
the Orbit Designer software program identifying a tangential alignment of the payload with the stable orbit in response to the height difference, direction α_{F}, thrust F_{D}, and descent burn time T_{BD}; and,
the Orbit Designer software program identifying an attainment of a stable orbit subsequent to burning the first amount of propellant.

23. The method of claim 22 wherein the target height is expressed with a scaling factor S_{f}, where:
$${r}_{f 1} r = S f {1}_{r} 1 < {s}_{f} < 2$$

24. The method of claim 23 wherein launching the payload to the target height includes:
$${r}_{h 1} = {s}_{f} \cdot a where 1.1 < {s}_{f} < 2.$$
where vₑ is exhaust gas velocity relative to the descent rocket;
where m_{ORBIT} is the mass of the satellite and the descent rocket;
where m₀ is the mass of the satellite, the descent rocket, and the mass of the first amount of propellant m_{PROP} at the target height;
where rₕ₁=2a for m_{PROP}=0 and,
where rₕ₁≤2a for m_{PROP}≥0.

25. The method of claim 22 wherein launching the payload to the target height includes the Orbit Designer software program initially identifying an alignment of the descent rocket in a (x₂, y₂) plane at the target height; and,
the method further comprising:
the Orbit Designer software program identifying a rotation of the payload to align in the (x₁, y₁) plane; and,
wherein the Orbit Designer software program identifying the satellite attaining the stable orbit includes attaining a stable orbit at any orbital inclination angle in the range between 0 and 360 degrees.

26. A method of obtaining launch trajectories for one of a plurality of potential orbital configurations using Orbital Designer computer processor instructions stored on a non-transitory memory, the instructions comprising:
for a payload including a descent rocket, a satellite, and a first amount of propellant, calculating a target height (rₕ₁) with respect to the center of the Earth;
calculating a stable orbit around the Earth defined by the formula:
$$\frac{1}{2} {{m}_{ORBIT} [ {v}_{e} ln ( \frac{{m}_{0}}{{m}_{ORBIT}} ) ]}^{2} - G \frac{{Mm}_{0}}{{r}_{h 1}} = - G \frac{{Mm}_{ORBIT}}{2 a}$$
$${r}_{h 1} = \frac{1}{{\frac{1}{2 GM} [ {v}_{e} ln ( 1 + \frac{{m}_{PROP}}{{m}_{ORBIT}} ) ]}^{2} + \frac{1}{2 a}}$$
where a is a semi-major axis along a x₁ axis passing through the Earth;
where b is a semi-minor axis along a y₁ axis, orthogonal to the x₁ axis;
calculating a height difference between the target height and a;
calculating a direction α_{F}, thrust F_{D}, and descent burn time T_{BD} from the target height;
calculating a decrease in the payload height in response to the pull of gravity;
calculating a tangential alignment of the payload with the stable orbit in response to the height difference, direction α_{f}, thrust F_{D}, and descent burn time T_{BD}; and,
calculating an attainment of the satellite in a stable orbit subsequent to burning the first amount of propellant.

27. The instructions of claim 26 wherein the target height is expressed with a scaling factor S_{f}, where:
$${r}_{h 1} = {s}_{f} \cdot a where 1.1 < {s}_{f} < 2.$$

28. The instructions of claim 27 wherein calculating the target height includes:
$$\frac{1}{2} {{m}_{ORBIT} [ {v}_{e} ln ( \frac{{m}_{0}}{{m}_{ORBIT}} ) ]}^{2} - G \frac{{Mm}_{0}}{{r}_{h 1}} = - G \frac{{Mm}_{ORBIT}}{2 a}$$
$${r}_{h 1} = \frac{1}{{\frac{1}{2 GM} [ {v}_{e} ln ( 1 + \frac{{m}_{PROP}}{{m}_{ORBIT}} ) ]}^{2} + \frac{1}{2 a}}$$
where vₑ is exhaust gas velocity relative to the descent rocket;
where m_{ORBIT} is the mass of the satellite and the descent rocket;
where m₀ is the mass of the satellite, the descent rocket, and the mass of the first amount of propellant m_{PROP} at the target height;
where rₕ₁=2a for m_{PROP} and,
where rₕ₁≤2a for m_{PROP}≥0.

29. The instructions of claim 26 wherein calculating the target height calculating an alignment of the descent rocket in a (x₂, y₂) plane at the target height;
wherein calculating the tangential alignment of the payload with the stable orbit includes calculating a rotation of the payload to align in the (x₁, y₁) plane; and,
wherein calculating the satellite attaining the stable orbit includes calculating the attainment of the stable orbit at any orbital inclination angle in the range between 0 and 360 degrees.
